(19) United States
(12) Patent Application Publication
(10) Pub. No.: US 2025/0045600 A1
(43) Pub. Date: Feb. 6, 2025

(54) SYSTEMS AND METHODS FOR CHARGING A PLURALITY OF ELECTRIC ASSETS

(71) Applicant: PowerFlex Systems, LLC, San Diego, CA (US)

(72) Inventors: Zachary Jordan Lee, Los Altos, CA (US); Rajat Sethi, San Diego, CA (US); George Lee, Los Altos, CA (US); Robin Guarnotta, La Jolla, CA (US); Ted Lee, San Marino, CA (US)

(21) Appl. No.: 18/789,880

(22) Filed: Jul. 31, 2024

Related U.S. Application Data
(60) Provisional application No. 63/516,844, filed on Jul. 31, 2023.

(51) Int. Cl. G06N 5/01; B60L 53/68; B60L 55/00; H02J 13/00

(52) U.S. Cl. CPC G06N 5/01; B60L 53/68; H02J 13/00002; H02J 13/00028; B60L 55/00

(57) ABSTRACT

Certain aspects of the present disclosure provide techniques for charging a plurality of electric assets. One embodiment of a system includes EVSE for charging an EV, the EVSE including a three-phase transformer for sending energy to the EV and an edge environment that is coupled to the EVSE. The edge environment may include logic that causes the system to receive configuration information associated with the EVSE, where the configuration information includes a phase assignment for the EVSE, determine whether the phase assignment is labeled as unknown, where the phase assignment of unknown was applied in response to a determination that a previous phase assignment was invalid or missing, and generate an optimization problem for the EVSE. In some embodiments, the logic may cause the system to solve the optimization problem to generate a trajectory for the three-phase transformer and cause implementation of the trajectory on the EVSE.

### CROSS REFERENCE

This application claims the benefit of U.S. Provisional Application No. 63/516,844 filed Jul. 31, 2023, which is hereby incorporated by reference in its entirety.

### INTRODUCTION

Aspects of the present disclosure relate to charging a plurality of electric assets, and specifically to providing standardized management of distributed energy resources.

Electric vehicles (EVs), including plug-in hybrid and fully electric vehicles, are increasing in popularity around the world. It is expected that the proportion of new EVs sold each year out of the total number of vehicles sold will continue to rise for the foreseeable future. Moreover, while EV operators are primarily non-commercial (e.g., personal vehicles), commercial vehicle operators are increasingly adding EVs to their fleets for all sorts of commercial operations, thus adding to the number of EVs in operation throughout the world.

The shift from internal combustion engine (ICE)-powered vehicles to EVs requires significant supporting infrastructure anywhere EVs are operated. For example, electric vehicle charging stations, sometimes referred to as electric vehicle supply equipment (EVSE), need to be widely distributed so that operators of EVs are able to traverse the existing roadways without issue.

Charging electric vehicles is different from refueling ICE vehicles in many ways. For example, an ICE vehicle simply purchases fuel at a fuel pump and the user either pays at the counter or the fuel pump is coupled with a credit card processing machine for receiving payment. EV charging is different in at least that electricity may need to be load shared to provide a plurality of EVs with the desired charge. Further, the EVs themselves may utilize different protocols, thus adding to the complexity.

As such, many current solutions utilize adaptive load management to facilitate simultaneous charging across a plurality of EVs. In many of these current charging solutions, effective use of adaptive load management may depend on the accurate knowledge of electrical connections at a local premises, particularly the adaptive charging group (ACG) and phase assignment of each load to ensure that no equipment on the site is overloaded. However, accurate information about the phase to which a station is connected is not always available. For example, those installing the station may not accurately record the phase connections of each piece of equipment. In other cases, chargers may be utilized which were previously installed by another provider and do not have accurate phase information. Accordingly, there is a need for standardized management of distributed energy resources.

### SUMMARY

Certain aspects of the present disclosure provide techniques for charging a plurality of electric assets. One embodiment of a system includes EVSE for charging an EV, the EVSE including a three-phase transformer for sending energy to the EV and an edge environment that is coupled to the EVSE. The edge environment may include logic that causes the system to receive configuration information associated with the EVSE, where the configuration information includes a phase assignment for the EVSE, determine whether the phase assignment is labeled as unknown, where the phase assignment of unknown was applied in response to a determination that a previous phase assignment was invalid or missing, and generate an optimization problem for the EVSE. In some embodiments, the logic may cause the system to solve the optimization problem to generate a trajectory for the three-phase transformer and cause implementation of the trajectory on the EVSE.

Embodiments of a method include receiving, by a computing device, configuration information from an electric vehicle supply equipment (EVSE) for charging an electric vehicle (EV) utilizing a three-phase transformer, determining, by the computing device, whether a previous phase assignment is missing or invalid, and in response to determining that the previous phase assignment is missing or invalid, replacing, by the computing device, the previous phase assignment with the phase assignment of unknown. In some embodiments, the method includes determining, by the computing device, whether a phase assignment is labeled as unknown, generating, by the computing device, an optimization problem for the EVSE, and solving, by the computing device, the optimization problem to generate a trajectory for the three-phase transformer. Some embodiments include causing, by the computing device, implementation of the trajectory on the EVSE.

Embodiments of a non-transitory computer-readable medium are also provided. Some embodiments are configured to receive configuration information from an electric vehicle supply equipment (EVSE) for charging an electric vehicle (EV) utilizing a three-phase transformer, determine whether a previous phase assignment is missing or invalid, and in response to determining that the previous phase assignment is missing or invalid, replace the previous phase assignment with the phase assignment of unknown. Some embodiments are configured to determine whether a phase assignment is labeled as unknown, generate an optimization problem for the EVSE, and solve the optimization problem to generate a trajectory for the three-phase transformer. Some embodiments cause implementation of the trajectory on the EVSE.

### DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for providing standardized management of distributed energy resources, according to embodiments provided herein;

FIG. 2 depicts a software configuration for an edge environment, according to embodiments provided herein;

FIGS. 3A-3C depict device configurations for the edge environment, according to embodiments provided herein;

FIGS. 4A-4C depict hardware that may be utilized for the devices from FIGS. 3A-3C, according to embodiments provided herein;

FIG. 5 depicts a cloud environment for standardized management of distributed energy resources, according to embodiments provided herein;

FIGS. 6A, 6B depict a plurality of three-phase configurations that maybe utilized by EVSE, according to embodiments provided herein;

FIG. 7 depicts a flowchart for accounting for an unknown phase with conservative constraints, according to embodiments provided herein;

FIG. 8 depicts a flowchart for accounting for an unknown phase with single phase constraints, according to embodiments provided herein;

FIG. 9 depicts a flowchart for accounting for an unknown phase with hybrid constraints, according to embodiments provided herein;

FIG. 10 depicts a flowchart for building constraints in the form of inequality, according to embodiments provided herein;

FIG. 11 depicts another flowchart for building constraints in the form of inequality, according to embodiments provided herein;

FIG. 12 depicts a flowchart for generating a current object, according to embodiments provided herein; and

FIG. 13 depicts a flowchart for adding a current object, according to embodiments provided herein.

### DETAILED DESCRIPTION

Embodiments disclosed herein include systems and methods for charging a plurality of electric assets and specifically to standardized management of distributed energy resources. Specifically, embodiments provided herein provide a plurality of constraint sets which allow for the management of electrical loads with unknown phases. A first embodiment does not utilize partial knowledge of the phase assignments in a local premises and is typically not used with bi-directional equipment or generators. A second embodiment may track an additional “bias” term within a current object but allows for the utilization of partial knowledge of the phase assignments to improve a performance ratio and account for bi-directional equipment and generators with a known phase. A third embodiment allows load management to be applied in more scenarios including when adopting sites from other providers. Embodiments also allow load management providers to incrementally gather phase information manually or in an automated process. The systems and methods for providing standardized management of distributed energy resources incorporating the same will be described in more detail, below.

### Example Computing Environment for Providing an Edge Hardware Platform

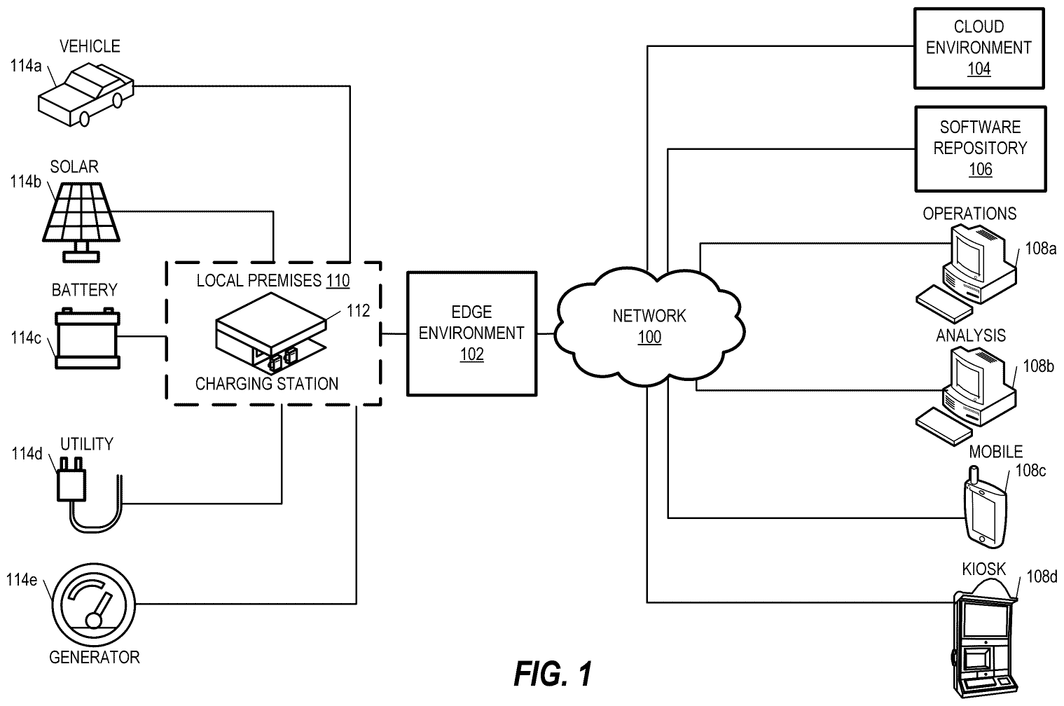

Referring now to the drawings, FIG. 1 depicts a computing environment for providing standardized management of distributed energy resources, according to embodiments provided herein. As illustrated, the computing environment includes a network 100 that is coupled to an edge environment 102, a cloud environment 104, a software repository 106, as well as one or more ancillary devices 108 (including an operations device 108a, an analysis device 108b, a mobile device 108c, and/or a kiosk device 108d). The network 100 may be configured as any wide area network (WAN, such as the internet, power network, cellular network, etc.) or other network for facilitating communication among the edge environment 102, the cloud environment 104, the software repository 106, and the ancillary devices 108.

Edge environment 102 may generally be deployed at a local premises 110 (also referred to herein as a site) to provide various services, including coordination and optimization of one or more energy assets 114 (including an EV 114a, a solar device 114b, a battery energy storage system (BESS) 114c, a utility grid 114d, and/or a generator 114e), such as charging of electric vehicles (e.g., EV 114a) using charging station 112 and controlling one or more of various distributed energy resources (DERs), such as solar device 114b, BESS 114c, utility grid 114d, and/or generator 114e (e.g., an on-site diesel, natural gas, or other type of fueled generator). Generally, the aforementioned DERs may provide energy to the charging station 112 and/or use energy from the charging station 112 (e.g., by way of a backflow of energy from EV 114a to other aspects of site 110). In some embodiments, charging station 112 may send excess energy back to the BESS 114c and/or to utility grid 114d. Generally, edge environment 102 may monitor and/or modify the energy sent to and received from the DERs to optimize various tasks, such as charging of EV 114a.

Charging station 112 may include one EVSE or a network of EVSE and/or other charging hardware that utilizes one or more of various communication protocols, such as open smart charging protocol (OSCP), open charge point interface (OCPI), ISO 15118, OpenADR, open charge point protocol (OCPP), etc. and may represent Level 1, Level 2, Level 3 (e.g., DC Fast Charging), and higher level charging stations, as applicable. Generally, the “level” of a charging station 112 refers to the power level and/or ability to provide electric power to a device being charged. The network of EVSE may include a plurality of network nodes, where each node is an EVSE.

Edge environment 102 is configured as an interface between various aspects of site 110 and network 100. In various embodiments, compute resources for performing different functions at a site 110, such as control or optimization of EV 114a charging, may be split between local compute resources in edge environment 102 and remote compute resources, e.g., in cloud environment 104 of FIG. 1.

Cloud environment 104 is coupled to the edge environment 102 via the network 100 and may be configured for further processing of data, as described herein. While FIG. 1 depicts a single cloud environment 104 that serves a single edge environment 102, this is merely an example, as some embodiments may be configured such that the cloud environment 104 may serve a plurality of edge environments 102 that each serve one or more sites 110, one or more charging stations 112, one or more DERs, and the like.

Software repository 106 is also coupled to site 110 via network 100. Software repository 106 may be configured as a platform to program, store, manage, control changes, etc. to software that is implemented in edge environment 102 and/or cloud environment 104. In some embodiments, software repository 106 may be configured as a proprietary service and/or may be provided by a third-party, such as GitHub™. Additionally, some embodiments may be configured such that the software repository 106 is provided by the same entity that manages the cloud environment 104. As such, these embodiments may be configured such that software repository 106 and cloud environment 104 may be combined.

With respect to the ancillary devices 108, the operations device 108a may be utilized to monitor and/or alter operations of the computing environment provided in FIG. 1. The analysis device 108b may analyze utilization, operation, charging, and/or other features of the computing environment provided in FIG. 1. The mobile device 108c may represent an administrator device and/or a user device. As a user device, the mobile device 108c may initiate charging, perform payment, and/or perform other user-specific actions. As an administrator device, the mobile device 108c may perform administrative operations, analysis, and/or other actions. The kiosk device 108d may be located at one of the charging stations 112 and/or remote therefrom and may provide user-specific or administrative actions, similar to that of the mobile device 108c. In some embodiments, one or more administrators may use the kiosk device 108d to view information about a site 110 or make changes. As will be understood by one of ordinary skill in the art, the ancillary devices 108 may each include one or more processors, one or more memory components, and/or other hardware and/or software for performing the functionalities provided herein. It should be understood that while the kiosk device 108d is depicted as being remote from the site 110, some embodiments may not be configured in this manner. Specifically, some embodiments may utilize a kiosk device 108d that is local at the site 110, which may communicate via a local network and/or the network 100 for providing the services described herein.

### Example Edge Environment

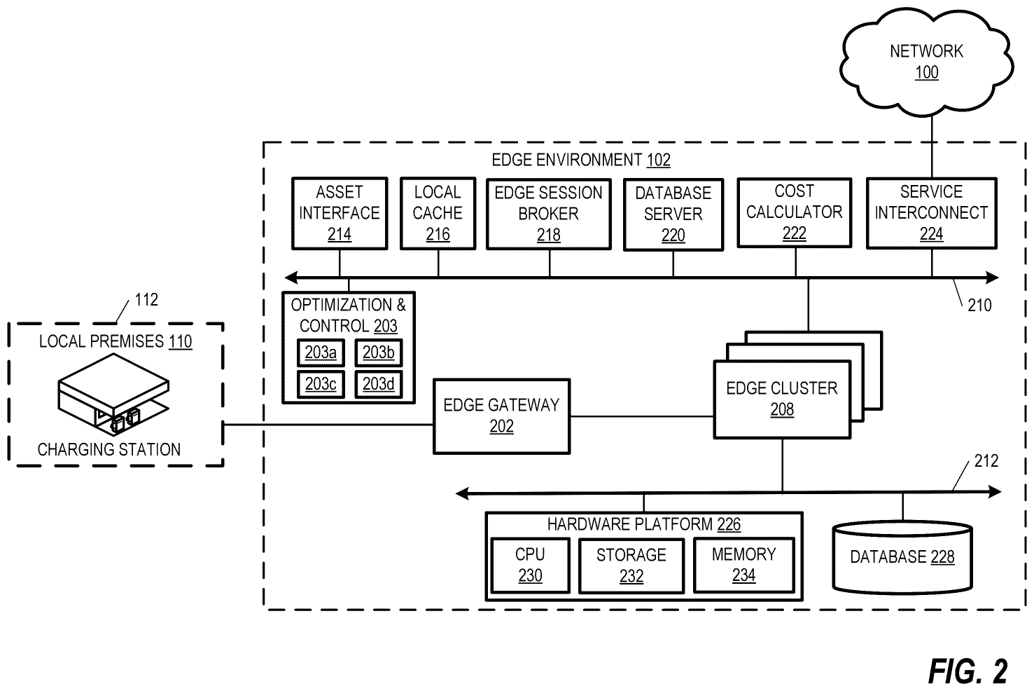

Referring now to FIG. 2, the edge environment 102 may be coupled to the site 110 via an edge gateway 202. Edge environment 102 may be operatively coupled to various aspects of site 110, such as charging station 112 via edge gateway 202. Edge environment 102 further includes an edge cluster 208, which is coupled to communication bus 210 and hardware bus 212. Communication bus 210 is coupled to optimization and control manager 203, asset interface 214, local cache 216, edge session broker 218, database server 220, cost calculator 222, and service interconnect 224 in this example. Hardware bus 212 is coupled to hardware platform 226, which may include one or more processors, such as CPU 230, one or more storage components 232, one or more memory components 234, and/or other hardware components. Also coupled to hardware bus 212 is database 228. Though certain components (e.g., cost calculator 222, database server 220, etc.) of edge environment 102 are depicted separate from hardware platform 226, they may be services or processes configured to run on hardware platform 226. Further, though certain components are illustrated as separate components, the functionality of such components may be combined into a single component and/or further divided among additional components.

Communication bus 210 and hardware bus 212 may be utilized to facilitate operation of all services that run in edge environment 102 and communicate with each other via a distributed message streaming system. The coupling of the aforementioned services may be accomplished in some embodiments via a distributed message streaming system, such as NATS.

In the depicted example, charging station 112 is configured for communication with edge environment 102 via edge gateway 202, such as via a short-range wireless network technology, such as via a Zigbee® PAN. The edge gateway 202 may be configured to receive data, such as electric vehicle charging data, price change data, vehicle data, etc. from the charging station 112 and/or vehicles that are being charged via the connection with the site 110 (of FIG. 1).

In some embodiments, edge gateway 202 may be configured to abstract data received from various aspects of site 110 (of FIG. 1), such as charging station 112, to remove protocol-specific distinctions. For example, a first charging station 112 may utilize a first communication protocol and/or billing protocol and a second charging station 112 may utilize a second communication protocol and/or billing protocol. Edge gateway 202 may receive data packets from both the first charging station using the first communication protocol and the second charging station using the second communication protocol and may transform the received data into a protocol-agnostic format prior to providing the data to edge cluster 208. This may allow wide interoperability between edge environment 102 and various types of hardware (e.g., charging station 112) at a site.

Edge cluster 208 is the central message center in various embodiments. For example, when a user plugs a vehicle into a charging station 112, edge cluster 208 receives data from edge gateway 202, parses that data (e.g., to generate access state data) and causes the state data to be sent to the database server 220.

The edge session broker 218 may produce data or signals that are sent to the edge cluster 208, which may be sent to the edge gateway 202 for potentially sending back to one or more of the charging stations 112. Information that may be reported might include current delivered over time (e.g., amperes), total energy delivered (e.g., kWh), power delivered over time (e.g., kW), voltage at the charging station 112 over time (e.g., V), charging station 112 state (e.g., connected, disconnected, offline), connectivity state, charging state, etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy assets 114.

Edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, mobile device 108c does not need to access edge environment 102 directly. Instead, mobile device 108c may connect with the cloud environment 104 (of FIG. 1), which sends a message to the edge cluster 208 with an instruction to claim the session. Service interconnect 224 is configured for establishing an HTTP, TCP, and/or other type of communication with the cloud environment 104 (of FIG. 1) via network 100.

The optimization and control manager 203 may provide energy optimization and adaptive load management (ALM) functions, for example, for various energy assets 114 at the site 110 (of FIG. 1). For example, the optimization and control manager 203 may be responsible for calculating set-points for each asset for the energy optimization and ALM amongst the energy assets 114 and providing data related to the calculated set-points to the asset interface 214. In some embodiments the optimization and control manager may perform the computations for allocating energy as described in the flowcharts below. In certain embodiments, the optimization and control manager 203 may include a database layer 203a to store data related to site configurations, an orchestration layer 203b to gather data and trigger optimizations, an optimization layer 203c to calculate set-points, and a control layer 203d for higher frequency feedback based controls. In some embodiments, the functionalities of the optimization and control manager 203 may be implemented, at least in part, within the cloud environment 104 (of FIG. 1).

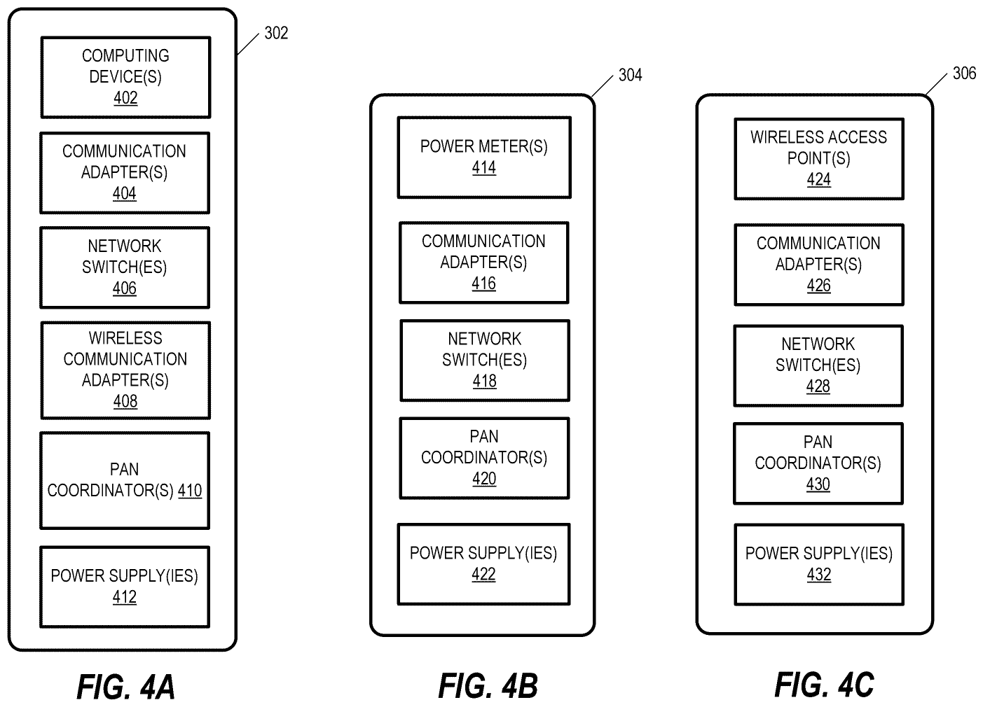

Hardware platform 226 represents any hardware for facilitating the processes and actions described herein. Specifically, one or more CPUs 230 may represent one or more types of processing device configured for executing instructions. One or more storage components 232 may be configured as long term storage, such as a hard drive or the like. One or more memory components 234 may include any of various types of random access memory or the like. One or more databases 228 may be configured for additional storage and may be housed with the other hardware and/or elsewhere. Examples of different hardware platforms that may be deployed in edge environment 102 are described further below with respect to FIGS. 4A-4C.

### Hardware Configurations for Edge Environment

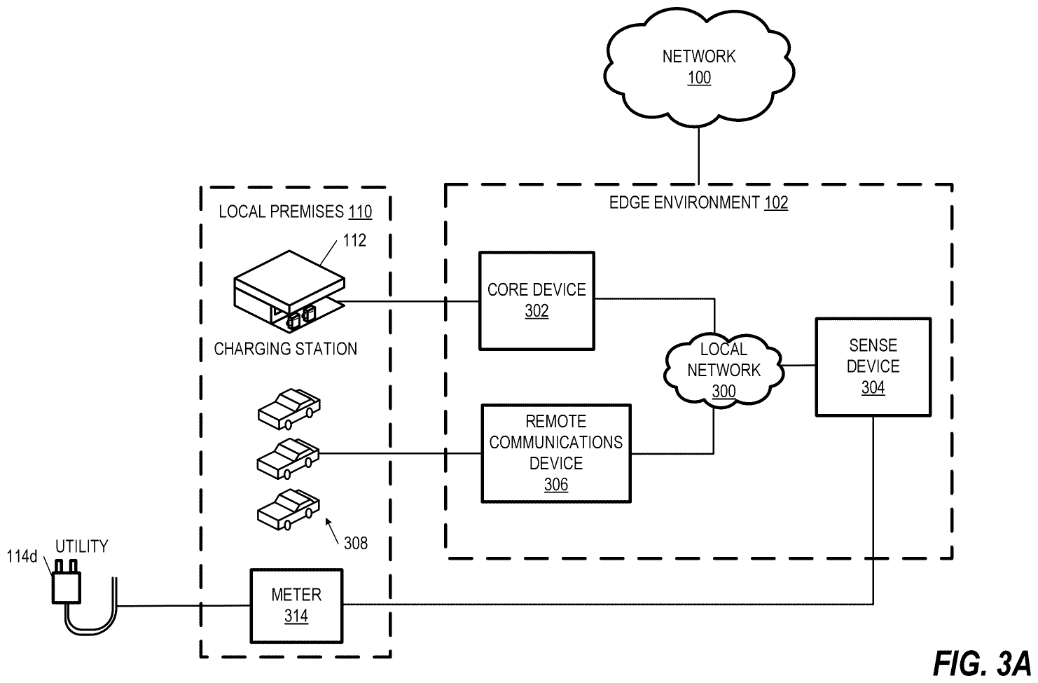

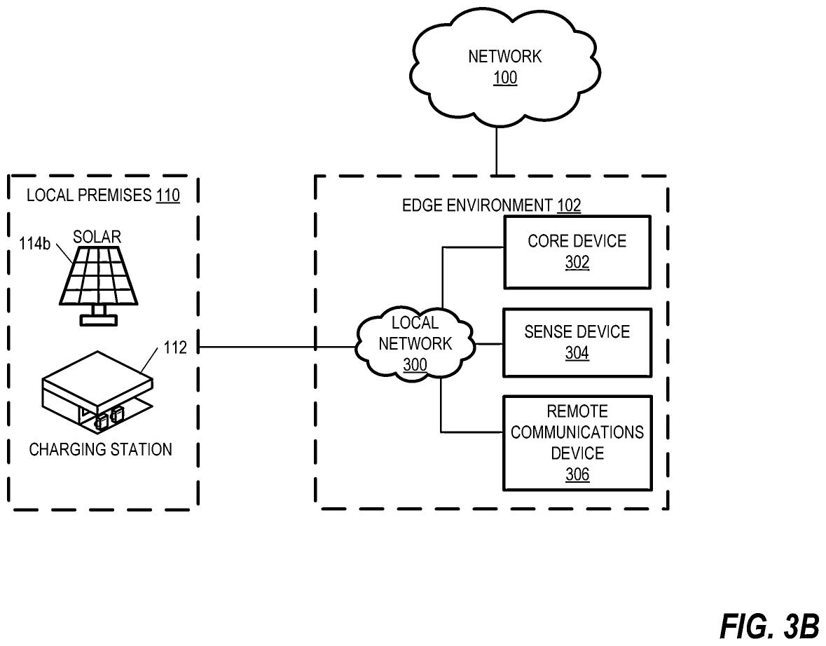

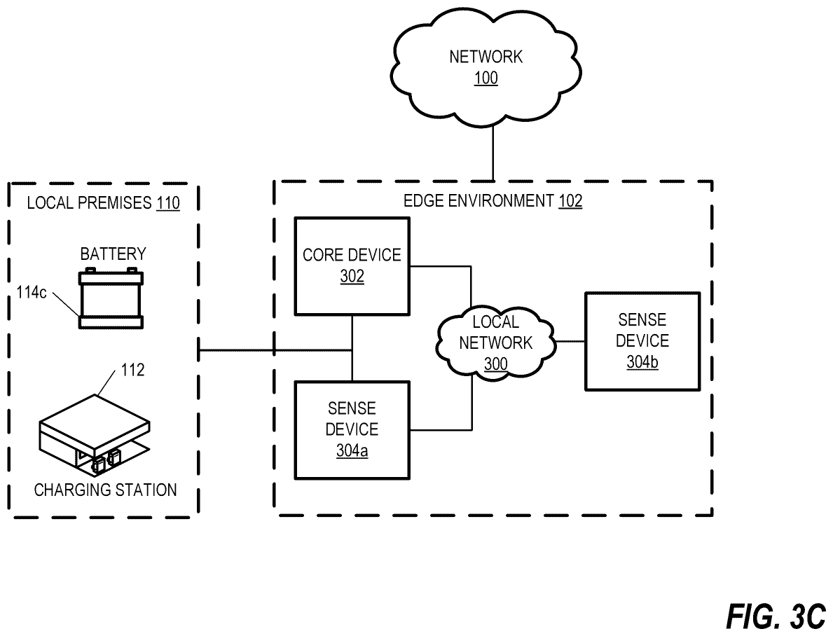

FIGS. 3A-3C depict example device configurations for edge environment 102, according to embodiments provided herein. Specifically, FIG. 3A depicts a charging solution. As illustrated, the charging station 112 is coupled to a local network 300 via a core device 302. The local network 300 may include any local area network, Ethernet, PAN, etc. The core device 302 may be physically installed within communications range of one or more chargers in the charging station 112. A sense device 304 may be installed, for example, in an electrical room or in another enclosure with electrical equipment of the charging station 112 and/or one or more energy assets 114 to monitor the main metering point for the local utility point of common coupling. This may enable one or more algorithms to provide the optimal dispatch of EV charging power, subject to local energy rates and the vehicles currently charging. In the case that there are vehicles 308 using EV chargers that are out of communications range of the core device 302, such as a sub-level of a parking garage, one or more remote communications devices 306 are included as required. Also included at the site 110 is a meter 314 for communicating energy with the utility grid 114d.

The core device 302 shown in FIG. 3A is the central processing device and serves as the communications hub. In certain embodiments, the components of FIG. 2 may generally operate, at least in part, as part of the core device 302. The core device 302 may provide optimization, load management, communication coordination, and/or data historian services. The core device 302 may communicate with the cloud environment 104 via cellular modem, wired internet service provider (ISP), and/or other communications medium to get current optimization and load management set points for charging stations 112 and/or other assets, such as via an optimization algorithm that may be stored locally and/or at the cloud environment 104. It will be understood, however, that some embodiments may be configured such that the core device 302 performs optimization locally. In certain embodiments, the core device 302 dispatches these set points, through a local communications protocol (e.g., Wi-Fi) and/or via the remote communications device 306 to reach locations that are distant or hard to reach, such as charging stations 112 with a core device 302 and/or sense device 304 at sub-levels of a parking garage or a rooftop solar inverter. The core device 302 may additionally or alternatively collect data directly from distributed energy resources and power measurement devices or through cloud-based communications with the network 100.

Power and energy metering data may be collected via the sense device 304. The sense device 304 may include a smart meter with support for multiple single- and three-phase loads, such as with a local historian and Ethernet communication back to the device via the local network 300. The sense device 304 may also incorporate support for additional devices running on the edge including but not limited to thermocouple wiring, weather stations, temperature sensors, pyranometers, etc. It should be noted that additional sense devices 304 and remote communications devices 306 can be added to handle a variety of situations, such as a separate subpanel for energy metering of a new solar system or for monitoring of a new inverter associated with a rooftop solar installation.

FIG. 3B depicts a solar application where the core device 302 and the sense device 304 are installed in an electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 (including a first sense device 304a and a second sense device 304b) are installed physically near the BESS 114c. In some cases where the BESS 114c is near the point of common coupling with the utility grid 114d, a single sense device 304a can monitor the full site. In some cases where there is a significant distance to the metering point for the utility grid 114d, the second sense device 304b (or a plurality of second sense devices 304b) may be installed near the utility meter, such as the electrical room.

### Hardware Components in Core, Sense, and Remote Communications Devices

FIGS. 4A-4C depict hardware that may be utilized for the devices from FIGS. 3A-3C, according to embodiments provided herein. Specifically, FIG. 4A depicts hardware components that may be present in core device 302. In some embodiments, the core device 302 is the brain where the energy optimization and adaptive load management (ALM) functions (e.g., by the optimization and control manager 203 of FIG. 2) are executed and dispatched. As illustrated, the core device 302 may include one or more computing devices 402, one or more communication adapters 404, one or more network switches 406, one or more wireless communication adapters 408, one or more PAN coordinators 410, and/or one or more power supplies 412. As will be understood, the computing device(s) 402 may include one or more processors, one or more memories, and/or other components that a conventional, specific-purpose machine may utilize. In some embodiments, the computing device(s) 402 may include power line communication (PLC) infrastructure, while some embodiments may utilize retail and/or micro-industrial computer components for optimization, load management, communication coordination, and/or historian services.

The communication adapter(s) 404 may be configured for load balancing and otherwise managing communications of E.G. Modubus RTU (RS485) to Modbus TCP (Ethernet) or Ethernet IP (RJ45) to Ethernet Optical (SFP), etc. The network switch(es) 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter(s) 408 may include a cellular modem, internet modem, Wi-Fi access point, etc. for facilitating wireless communications to the internet or other wide area network. Similarly, the PAN coordinator(s) 410 may be configured to create and/or join communication connections with other devices. This may include a Zigbee coordinator, Bluetooth device, and/or other device for performing this function. The power supply (ies) 412 may be configured as battery power, connection to external power, etc.

FIG. 4B depicts hardware components of the sense device 304 from FIGS. 3A-3C. The sense device 304 may be configured as a smart-metering piece for collection and storage of power/energy data such as measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. Certain embodiments may be optimized for ease of installation and reduced intrusion to the site. Power over Ethernet (POE) sourced from the core device 302 may suffice for most installations. The sense device 304 may transmit data back to the core device 302 via a network switch. The sense device 304 may be optimized to utilize minimal power, and PoE may be acceptable for most installations.

As illustrated in FIG. 4B, the sense device 304 includes one or more power meters 414, one or more communication adapters 416, one or more network switches 418, one or more PAN coordinators 420, and/or one or more power supplies 422. The power supply (ies) 422 may include a power interface for providing power to the sense device 304. The power meter(s) 414 may be utilized for monitoring single-phase and three-phase loads of power. The communication adapter(s) 416 may be utilized for facilitating communications between the sense device 304 and other devices. The network switch(es) 418 may be a PoE enabled switch for communication. Similarly, the PAN coordinator(s) 420 may create and/or join personal area networks, such as via Zigbee, Bluetooth, and the like. In some embodiments, PoE or other power source may be utilized.

As illustrated in FIG. 4C, the remote communications device 306 may be a network-connectivity extension, for example, for EV charging or solar monitoring locations where Zigbee, Wi-Fi, or Ethernet is being extended to remote or difficult-to-reach locations such as remote subpanels, parking garage levels, or rooftop inverters. Some embodiments are optimized for ease of installation and reduced intrusion to the site where PoE may suffice for most installations from the core device 302. The remote communications device 306 may be configured to transmit data back to the core device 302 via a network switch.

Specifically, the remote communications device 306 may include one or more wireless access points 424, one or more communication adapters 426, one or more network switches 428, one or more PAN coordinators 430, and/or one or more power supplies 432. The wireless access point(s) 424 may be configured to extend wireless communication signals to chargers and/or other intelligent electronic devices. The communication adapter(s) 426 may be configured for facilitating communications between the remote communications device 306 and other devices. The network switch(es) 428 may be configured as a PoE Ethernet switch and/or other network switch for communicating with the core device 302. The PAN coordinator(s) 430 may be configured to create and/or join personal area networks, such as via Zigbee, Bluetooth, and the like. The power supply(ies) 432 may include a power interface for providing power to the remote communications device 306.

### Example Cloud Environment

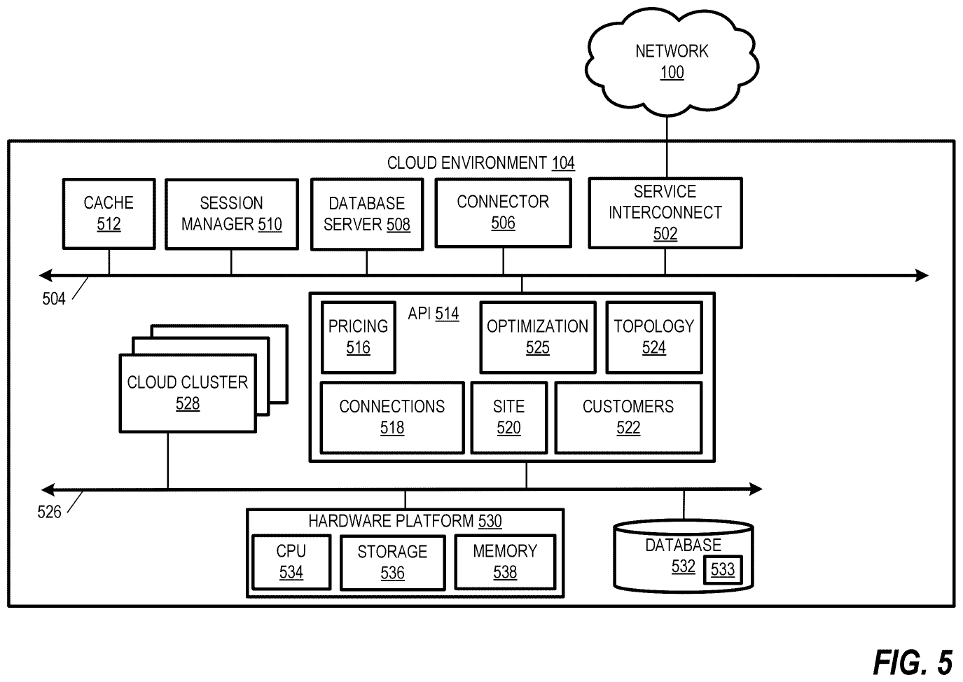

FIG. 5 depicts a cloud environment for standardized management of distributed energy resources, according to embodiments provided herein. As illustrated, the network 100 may couple to the cloud environment 104 via a service interconnect 502 that corresponds with the service interconnect 224 from FIG. 2. Similar to the service interconnect 224 from FIG. 2, the service interconnect 502 may be configured to facilitate an HTTP, TCP, and/or other communication portal through the network 100 to the edge environment 102 for the exchange of data between the edge environment 102 and the cloud environment 104. Additionally or alternatively, the service interconnect 502 may be configured to facilitate an HTTP, TCP, and/or other communication portal through the network 100 directly with an electric vehicle supply equipment (EVSE), such as charging station 112, for the exchange of data between the edge environment 102 and the EVSE. For example, in some such embodiments, cloud environment 104 may be configured with the same or similar components as edge environment 102 (e.g., in addition or alternative to one or more components shown in FIG. 5) and configured to perform functions similar to edge environment 102, such that a separate edge environment 102 may not be needed.

The service interconnect 502 is coupled to a communication bus 504, which facilitates communication among various components of FIG. 5. Also connected to the communication bus 504 are a NATS connector 506, a database server 508, a session manager 510, a cache 512, and a collection of services and at least one application programming interface (API) 514. The APIs 514 may include a pricing API 516, a connections API 518, a site API 520, a customer's API 522, a topology API 524, and/or an optimization API 525. The APIs 514 may be implemented by hardware platform 530. Hardware bus 526 is coupled to a NATS cloud cluster 528, as well as the hardware platform 530 and a database 532. The hardware platform 530 may include one or more CPUs 534, one or more storage components 536, and one or more memory components 538. Though certain components of cloud environment 104 are depicted separate from hardware platform 530, they may be services or processes configured to run on hardware platform 530. Further, though certain components are illustrated as separate components, the functionality of such components may be combined into a single component and/or further divided among additional components.

The API 514 is a component of the cloud environment 104. As such, the API 514 (including the pricing API 516, the connections API 518, the site API 520, the customer's API 522, the topology API 524, and/or the optimization API 525) may cause storage of and/or process site information, site topology, customers, connections to panels, constraints of panels, pricing information of each site, local forecasting services, optimization services, controller services, caching services, etc. The APIs 514 may also serve as a mobile backend by storing personal information of charge users (e.g., email, charging preferences, payment preferences, privileges, access, fleet information, etc.). The APIs 514 may additionally store peak charging configurations, data related to meter setup, etc. In some cases, the API 514 may also be responsible for tracking changes to EVSE connections and causing related changes to various types of data. For example, a newly connecting EVSE may create a new charging session, and a newly disconnecting EVSE may close a charging session. The connection and the disconnection may cause changes in payment information for user(s) of the connecting or disconnecting EVSE(s), for example, related to payment for energy usage. In some embodiments, the pricing API 516 may be used for storing information related to pricing configuration of a charging site, such as the site 110 (of FIG. 1). Some examples of the information related to pricing configuration of a charging site may include, but not be limited to, cost for energy (e.g., $/kWh), cost for parking time (e.g., $/time-interval), cost for idle parking time (e.g., $/idle-time-interval), etc. In certain embodiments, the site API 520 may be or include a service that provides an API to read or change information about a charging site (e.g., site name, address, etc.). The topology API 524 may be used for storing information related to topology of EVSEs, and may be utilized to track, for example, which EVSEs are connected to which electrical panels and whether any electrical panels may be subpanels of other panels. Such information may be utilized for load management. In some embodiments, the optimization API 525 may be responsible for handling optimization requests, performing one or more optimization methods, and communicating the result of the optimization. For example, the optimization API 525 may be or include a service that may be executed when there is a newly connected or disconnected EVSE, such that an optimization may be performed to allocate (e.g., re-allocate) power according to updated state(s) of the EVSE(s).

When a vehicle is plugged into a charging station 112 (FIG. 1), the edge session broker 218 (FIG. 2) may communicate connection information to the API 514. The connection information may include vehicle information, user information, charging station information, etc. The API 514 then create a charge session object, which is stored in the cache 512. The cache 512 sends the session data, along with topology constraints and the charge session object to the edge environment 102. The NATS connector 506 may additionally cause the NATS cloud cluster 528 to maintain the charge session object for retrieval by an interested party. As the session continues, the session manager 510 may be utilized to alter constraints of the session, which may cause the NATS cloud cluster 528 to update the charge session object.

When a user claims a previously created session with the mobile device 108c, the database server 508 may create a database entry (e.g., within the database 532) with the charge session, driver, energy request, willingness to pay, electricity purchased, etc. The NATS connector 506 may update the NATS cloud cluster 528 with the database entry. This data may then be sent to the edge environment 102. When the charge session ends (e.g., when the vehicle is unplugged), that action may be added to the database entry and the database entry may be moved from a current sessions list to a completed sessions list.

In certain embodiments, the database 532 may include optimization data 533 related to, for example, optimization scenarios (e.g., past optimization scenarios which may be used for debugging and/or auditing the performance of a given optimization scheme).

As indicated above, the hardware platform 530 may represent hardware that may be utilized to execute the components described regarding FIG. 5. As such, the CPU(s) 534 may be configured as any processing unit for receiving and executing computer-readable instructions. The storage component(s) 536 may be configured as any hard drive or other local storage device. The memory component(s) 538 may be configured as any type of RAM, ROM, registers, etc. or the like.

### Example Three-Phase Configurations

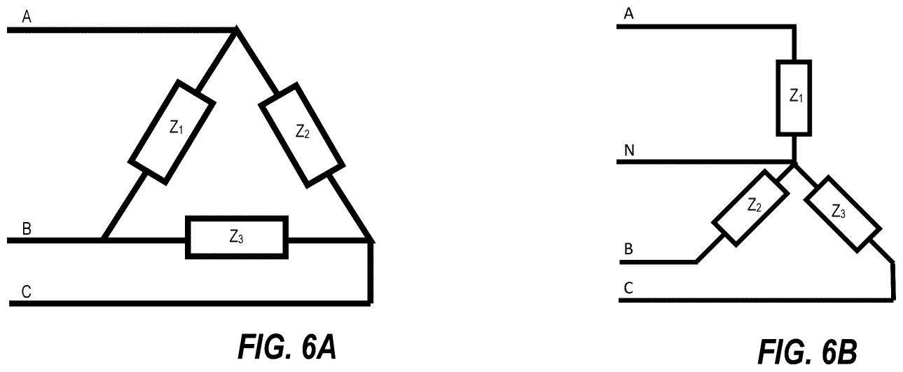

FIGS. 6A, 6B depict a plurality of three-phase transformer configurations that may be utilized by a charging station 112 and/or EVSE, according to embodiments provided herein. As will be understood, a transformer is a device that transfers electric energy from one alternating-current circuit to one or more other circuits, either increasing (stepping up) or reducing (stepping down) the voltage. Due to space restrictions and/or performance demands, many EVSE utilize one or more three-phase transformers. A three-phase transformer can be constructed either by connecting together three single-phase transformers or by using one pre-assembled and balanced three phase transformer with three pairs of single phase windings mounted onto one single laminated core. As such, FIG. 6A depicts a delta configuration of a three-phase transformer. In a delta configuration, the three windings or impedances (Z₁, Z₂, Z₃) are connected end-to-end to form a closed path. A phase (A, B, C) is connected to each corner of the delta. Generally speaking, each phase is 120 degrees apart from the other phases.

FIG. 6B similarly depicts a star or “wye” configuration of a three-phase transformer. In a wye configuration, one end of each of the three windings (Z₁, Z₂, Z₃) is connected to form a neutral. A phase (A, B, C) is connected to the other end of the three windings (Z₁, Z₂, Z₃). The neutral (N) is usually grounded.

As discussed above, when a transformer is installed at a local premises 110, often times, the installer does not identify how each charger is connected; the charger connections are listed incorrectly, and/or the listed chargers are invalid. This may significantly limit the efficiency of the EVSE because the EVSE must operate in a lowest efficiency to reduce the likelihood of a blown breaker or other malfunction. Thus, embodiments provided herein may be configured to operate when the phase values are not known. Some embodiments, utilize the process described below, by first letting rᵢ(t)∈ [symbol] ⁺ represent the magnitude of the current drawn by the i-th EVSE, and let Iₖ(t)∈ [symbol] ⁴ denote the current on each phase A, B, C, and N at ACG k. Define νₖ as the set of EVSEs which are descendants of ACG k.

In these embodiments, Rᵢ(t)∈ [symbol] ⁴ represents a vector of the line current contribution of the i-th EVSE. Rᵢ(t), which can be computed using the equation Rᵢ(t): =rᵢ(t) P_{ϕ}, where ϕ represents the phase of the EVSE and can take the values A, B, C, AB, BC, CA, or ABC. The quantity P_{ϕ}∈ [symbol] ⁴ describes how the EVSE is connected to the network and its phase angle. For example:

$${P}_{A} := [ {e}^{j {θ}_{A}} , 0 , 0 , - {e}^{j {θ}_{A}} ] ,$$

$${P}_{B} := [ 0 , {e}^{j {θ}_{B}} , 0 , - {e}^{j {θ}_{B}} ] ,$$

$${P}_{C} := [ 0 , 0 , {e}^{j {θ}_{C}} , - {e}^{j {θ}_{C}} ] ,$$

$${P}_{A B} := [ {e}^{j {θ}_{A B}} , - {e}^{j {θ}_{A B}} , 0 , 0 ] ,$$

$${P}_{B C} := [ 0 , {e}^{j {θ}_{B C}} , - {e}^{j {θ}_{B C}} , 0 ] ,$$

$${P}_{C A} := [ - {e}^{j {θ}_{C A}} , 0 , {e}^{j {θ}_{C A}} , 0 ] ,$$

$${P}_{A B C} := [ \frac{{e}^{j {θ}_{A}}}{3} , \frac{{e}^{j {θ}_{B}}}{3} , \frac{{e}^{j {θ}_{C}}}{3} , 0 ] .$$

Then define:

$${I}_{k} ( t ) = {\sum }_{i ∈ {V}_{k}} {R}_{i} ( t ) = {\sum }_{i ∈ {V}_{k}} {r}_{i} ( t ) {P}_{{ϕ}_{i}} . \qquad ( 1 )$$

The constraint on Iₖ(t) is such that the magnitude of each element in the vector should not exceed a limit Lₖ(t), specifically:

$$‖ {I}_{k}^{j} ( t ) ‖ \leq {L}_{k} ( t ) , ∀ j ∈ \{ 0 , 1 , 2 , 3 \} . \qquad ( 2 )$$

To handle unknown phase assignments, one approach is to use the sum of the current magnitudes of all equipment in an ACG. As a a simple example involving three EVSEs, one on phase AB, one on BC, and one on CA, the actual constraints would be:

$$‖ {r}_{0} ( t ) + {r}_{2} ( t ) {e}^{\frac{2 π}{3} j} ‖ \leq {L}_{k} ( t ) ,$$

$$‖ - {r}_{0} ( t ) + {r}_{1} ( t ) {e}^{- \frac{2 π}{3} j} ‖ \leq {L}_{k} ( t ) ,$$

$$‖ {r}_{1} ( t ) {e}^{- \frac{2 π}{3} j} + {r}_{2} ( t ) {e}^{\frac{2 π}{3} j} ‖ \leq {L}_{k} ( t ) .$$

The triangle inequality allows an approximation as follows:

$$‖ {r}_{0} ( t ) ‖ + ‖ - {r}_{2} ( t ) {e}^{\frac{2 π}{3} j} ‖ \leq {L}_{k} ( t ) ,$$

$$‖ - {r}_{0} ( t ) ‖ + ‖ {r}_{1} ( t ) {e}^{- \frac{2 π}{3} j} ‖ \leq {L}_{k} ( t ) ,$$

$$‖ - {r}_{1} ( t ) {e}^{\frac{2 π}{3} j} ‖ + ‖ {r}_{2} ( t ) {e}^{\frac{2 π}{3} j} ‖ \leq {L}_{k} ( t ) .$$

Simplifying results in the following:

$${r}_{0} ( t ) + {r}_{2} ( t ) \leq {L}_{k} ( t ) ,$$

$${r}_{0} ( t ) + {r}_{1} ( t ) \leq {L}_{k} ( t ) ,$$

$${r}_{1} ( t ) + {r}_{2} ( t ) \leq {L}_{k} ( t ) .$$

This approximation still relies on knowledge of the phase assignment of each EVSE. However, r₀(t)≥0, r₁(t)≥0, and r₂(t)≥0. This means that the remaining current can be added to the left side of each inequality. This makes all three inequalities the same, and means which phase each EVSE is connected to is not necessary. Specifically:

$${r}_{0} ( t ) + {r}_{1} ( t ) + {r}_{2} ( t ) \leq {L}_{k} ( t ) \qquad ( 3 )$$

Considering the current constraints for a single ACG:

$$‖ {\sum }_{i ∈ {𝒱}_{k}} {r}_{i} ( t ) {P}_{{ϕ}_{i}}^{j} ‖ \leq {L}_{k} ( t ) ∀ j ∈ \{ 0 , 1 , 2 , 3 \} \qquad ( 4 )$$

Applying the triangle inequality results in the following:

$${\sum }_{i ∈ {𝒱}_{k}} {r}_{i} ( t ) ‖ {P}_{{ϕ}_{i}}^{j} ‖ \leq {L}_{k} ( t ) ∀ j ∈ \{ 0 , 1 , 2 , 3 \} \qquad ( 5 )$$

which, given that each element in P_{ϕ}_{ᵢ} has a norm between 0 and 1 by construction,

$$‖ {P}_{{ϕ}_{i}}^{j} ‖$$

can be removed, leaving:

$${\sum }_{i ∈ {𝒱}_{k}} {r}_{i} ( t ) \leq {L}_{k} ( t ) \qquad ( 6 )$$

This approximation is equivalent to replacing all P_{ϕ}_{ᵢ} with P_{Ã} in the original constraint and generalizes to arbitrary numbers of EVSEs. This yields the constraint:

$${\sum }_{i ∈ {𝒱}_{k}} {r}_{i} ( t ) \leq {L}_{k} ( t ) \qquad ( 7 )$$

In systems designed to incorporate current magnitude constraints of the form:

$$‖ {\sum }_{i ∈ {𝒱}_{k}} {r}_{i} ( t ) {P}_{{ϕ}_{i}}^{j} ‖ \leq {L}_{k} ( t ) ∀ j ∈ \{ 0 , 1 , 2 , 3 \} \qquad ( 8 )$$

will generally model a current as a variable rᵢ and a known phase assignment ϕᵢ for a fixed set of ϕᵢ, i.e., A, B, C, AB, BC, CA, ABC. In this model, Inequality (7) cannot be directly incorporated. Instead, the same effect can be accomplished by assigning all equipment to a single phase ϕ, for example, A.

$${\sum }_{i ∈ {𝒱}_{k}} {r}_{i} ( t ) ‖ 1 ‖ \leq {L}_{k} ( t )$$

$${\sum }_{i ∈ {𝒱}_{k}} {r}_{i} ( t ) ‖ 0 ‖ \leq {L}_{k} ( t )$$

$${\sum }_{i ∈ {𝒱}_{k}} {r}_{i} ( t ) ‖ 0 ‖ \leq {L}_{k} ( t )$$

$${\sum }_{i ∈ {𝒱}_{k}} {r}_{i} ( t ) ‖ - 1 ‖ \leq {L}_{k} ( t )$$

This simplifies to Inequality (7).

It should be noted that this will work for phase A, B, C, AB, BC, or CA since each as at least one element in P_{ϕ} with norm 1 and all other elements have a norm between 0 and 1 inclusive, which allows us to simplify the constraints into Inqeuality (7). This does not, however, work for phase ABC. In the definition of P_{ABC} it is assumed to be a balanced operation, so the current magnitude can be divided equally among the three phases. This results in the elements of P_{ABC} having magnitude

$$\frac{1}{3}$$

or 0 which will not simplify into Inequality (13).

This approach is a conservative approximation. To understand the extent of its conservatism, one may consider the case when all phases are equally utilized, which we term as the “balanced” scenario. In such a situation, this approximation tends to limit throughput.

Let V_{LN}(t) by the nominal line to neutral voltage of the system at ACG k. The maximum throughput in balanced operations is 3*V_{LN}(t)*Lₖ(t). The maximum total current draw when enforcing Inequality (7) is Lₖ(t). This means that if the loads are connected line to neutral, the maximum power this system can supply to loads is V_{LN}*Lₖ(t). This results in a performance ratio of frac13 or 33.33%.

Fortunately, most commercial charging systems are connected line-to-line rather than line-to-neutral. This results in a max power delivery of \sqrt{3}V_{LN}(t)Lₖ(t) due to the increased voltage across the load. Therefore, the ratio between the theoretical maximum and the conservative approximation for these systems is

$$\frac{1}{\sqrt{3}} ,$$

approximately 57.7%.

These performance ratios rely on a relatively mild assumption that the voltage is relatively constant and unaffected by the current draw and potential unbalance. This conservative approach is applicable for loads. In many cases, this approach is not used with bi-directional equipment like stationary batteries or generation equipment like solar PV. To see this, assume that a battery is being utilized. The charging current of the battery a b(t). b(t)>0 implies the battery is charging while b(t)<0 implies the battery is discharging. However, when the triangle inequality is applied, this directional information is lost. This means that if the conservative approach is applied, the battery would decrease the capacity available to other loads, such as EVSE, even when it was discharging, which is the opposite of the desired effect. While the resulting system would still be safe, the resulting system may be too conservative.

The on-sight equipment may be into two sets, a set with known phases, denoted [symbol] and a set with unknown phase, which is denoted [symbol] . Similarly, let [symbol] ₖ and [symbol] ₖ be the set of equipment which is a descendent of ACG k with known and unknown phases respectively. In this new model:

$${I}_{k}^{j} ( t ) = {\sum }_{i ∈ {k}_{}} {R}_{i}^{j} ( t ) + {\sum }_{i ∈ {k}_{}} {R}_{i}^{j} ( t ) \qquad ( 9 )$$

and

$${‖I}_{k} ( t ) ‖ = ‖ {\sum }_{i ∈ {k}_{}} {R}_{i}^{j} ( t ) + {\sum }_{i ∈ {k}_{}} {R}_{i}^{j} ( t ) ‖ \qquad ( 10 )$$

It should be noted that Σ_{i∈} [symbol] _{ₖ}Rᵢ(t) and Σ_{i∈} [symbol] _{ₖ}Rᵢ(t) are just vectors, so the triangle inequality can be applied, as before.

$${‖I}_{k}^{j} ( t ) ‖ \leq ‖ {Σ}_{i ∈ {k}_{}} {R}_{i}^{j} ( t ) ‖ + ‖ {Σ}_{i ∈ {k}_{}} {R}_{i}^{j} ( t ) ‖ \qquad ( 11 )$$

Since phases are known,

$$‖ {Σ}_{i ∈ {k}_{}} {R}_{i} ( t ) ‖$$

can be computed precisely, while for

$$‖ {Σ}_{i ∈ {k}_{}} {R}_{i} ( t ) ‖$$

the triangle inequality can be utilized again to arrive at the Inequality:

$$‖ {Σ}_{i ∈ {k}_{}} {R}_{i}^{j} ( t ) ‖ \leq {Σ}_{i ∈ {k}_{}} \vert {r}_{i} ( t ) \vert \qquad ( 12 )$$

This results in the following constraint:

$$\begin{matrix}{‖I}_{k}^{j} ( t ) ‖ \leq ‖ {\sum }_{i ∈ {k}_{}} {r}_{i} ( t ) {P}_{{ϕ}_{k}}^{j} ‖ + {\sum }_{i ∈ {k}_{}} \vert {r}_{i} ( t ) \vert \leq {L}_{k} ( t ) & j ∈ \{ 0 , 1 , 2 , 3 \}\end{matrix} \qquad ( 13 )$$

This allows an improvement in the performance ratio by incorporating known phase information into the optimization even when not all equipment phases are known. The actual performance ratio depends on the percentage of load in the known group [symbol] and the unknown group U. If κ is the ratio of load in the known group, then the performance ratio can be given by λₘ=κ+(1−κ)/λ_{c} where λₛ is the performance ratio of the single phase approximation (0.333 in the case of line-to-neutral loads and 0.577 in the case of line-to-line loads). Note that λₘ≥λₛ, in other words, the mixed approach is always better than or at least equal to the performance of the single phase approximation. This solution also allows for generation and bi-directional assets to be combined with loads with unknown phase, which is an additional benefit.

However, this approximation will allow for bi-directional equipment and generators if the phase of this equipment is known. Because the absolute value in Inequality (13), directional information may be lost if the phase information is not known for assets that can export current.

Unfortunately, Inequality (13) cannot be easily transformed into Inequality (15). Instead, the structure of the constraint must be modified to include a constant term in addition to the vector Iₖ(t). This constant term is denoted Bₖ(t).

$${B}_{k} ( t ) = {\sum }_{i ∈ {k}_{}} \vert {r}_{i} ( t ) \vert \qquad ( 14 )$$

Which yields at a modified constraint:

$$\begin{matrix}‖ {\sum }_{i ∈ {v}_{k}} {r}_{i} ( t ) {P}_{{ϕ}_{i}}^{j} ‖ + {B}_{k} \leq {L}_{k} ( t ) & ∀ j ∈ \{ 0 , 1 , 2 , 3 \}\end{matrix} \qquad ( 15 )$$

It should be noted that this modification requires a change to the way the current is stored at ACG k. Rather simply storing the line currents on lines A, B, C, and N, this scalar term made up of the sum of the current magnitudes of equipment with unknown phase need also be stored.

Specifically, some embodiments model ACG currents using the current class. In this class a dictionary (hashmap) can be stored, which maps a line name (A, B, C, N) to a variable which models the aggregate current on that line over time as a vector of complex numbers. Each ACG is modeled as a network node which contains a current. This mixed phase process utilizes a modification of either the current class or the network node class to store the current magnitude of equipment connected with unknown phase. The current class supports basic arithmetic including addition, subtraction, and scalar multiplication. In the case of addition and scalar multiplication, it is straightforward that the unknown current magnitudes should be added together or multiplied by the scalar. In the case of subtraction, the magnitudes should still be added as required by the triangle inequality.

Example Process for Accounting for an Unknown Phase with Conservative Constraints

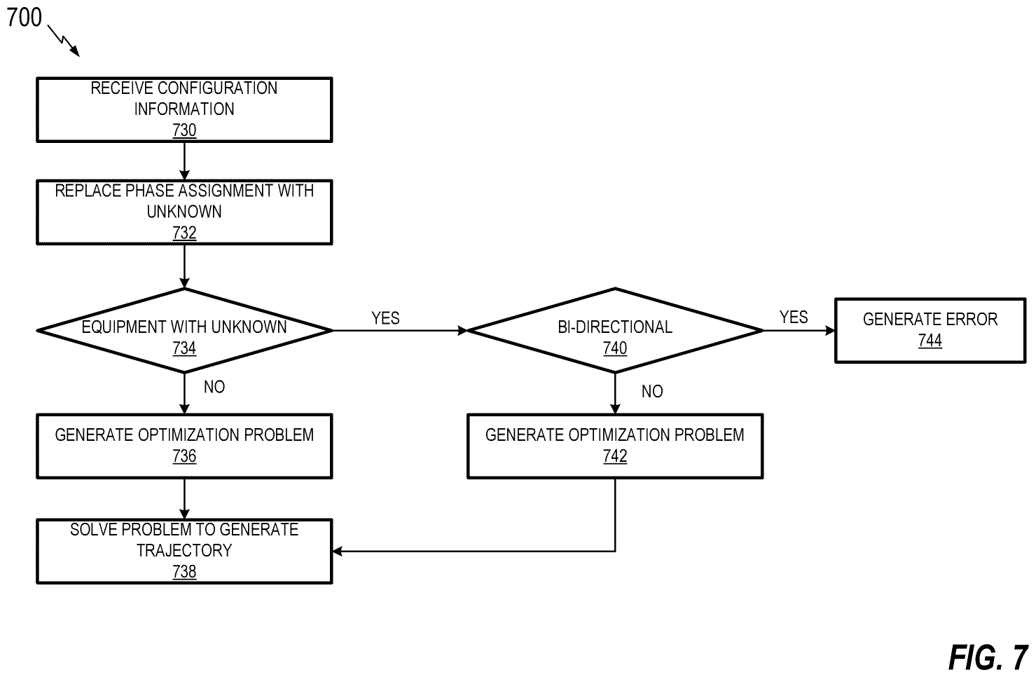

FIG. 7 depicts a flowchart 700 for accounting for an unknown phase with conservative constraints, according to embodiments provided herein. As illustrated in block 730, configuration information may be received related to local premises 110 and/or any related EVSE. In block 732, previous phase assignments that are invalid or missing may be replaced with an “unknown” label. It should be understood that in some embodiments, blocks 730, 732 may be performed in the cloud environment 104 (FIGS. 1, 5) and specially may be performed by the optimization API 525. At least a portion of this data may be determined from optimization data 533 stored in the database 532. Once the previous phase assignments are relabeled, this data may be sent to the edge environment 102 for processing via the optimization and control manager 203 (FIGS. 1, 2).

In block 734, a determination may be made by the optimization and control manager 203 regarding whether there is equipment with an “unknown” label. If there is no equipment with an “unknown” label, the process proceeds to block 736 where an optimization problem may be generated in the form of Inequality 8. In block 738, the problem may be solved to generate a charging/load trajectory.

Generating a charging/load trajectory may include causing a physical change in the charges that may be deployed by the EVSE. The charging load trajectory may include an output schedule for all EVSE at a predetermined local premises 110 (and/or other area) for a predetermined time period. The charging/load trajectory may be updated periodically (e.g., every 5 minutes, 10 minutes, 2 hours, etc.). In some embodiments, the charge/load trajectory may implemented such that if an EV connects to EVSE, there is a predetermined limit imposed that the EV can use from the EVSE. In some embodiments, the EVSE will receive the limit and/or other physical restriction put in place.

If, at block 734, there is equipment with an “unknown” label, the process may proceed to block 740 to determine whether any of the equipment is bi-directional and/or a generator. If not, an optimization problem may be generated at block 742 in the form of Inequality 7. The process may then proceed to block 738 to solve the optimization problem to generate the charging/load trajectory. If, at block 747 there are generators and/or bi-directional equipment, at block 744, an error may be generated. As discussed above, generating the charging/load trajectory may include implementing the charging/load trajectory.

Example Process for Accounting for an Unknown Phase with Single Phase Constraints

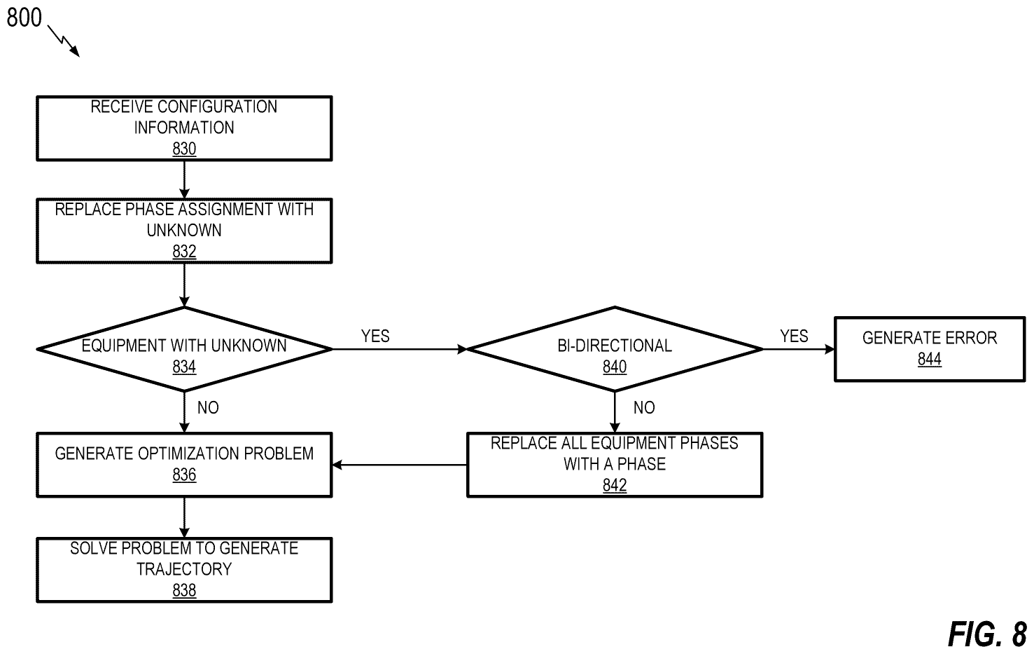

FIG. 8 depicts a flowchart 800 for accounting for an unknown phase with single phase constraints, according to embodiments provided herein. As illustrated in block 830, a configuration information may be received. At block 832, any previous phase assignments that are missing and/or invalid may be replaced with “unknown.” As discussed with regard to FIG. 7, the blocks 830, 832 may be performed in the cloud environment 104, such as via the optimization API 525. Blocks 834-844 may be performed via the edge environment 102, such as by the optimization and control manager 203.

At block 834, a determination may be made regarding whether there is any equipment with an “unknown” label. If not, the process proceeds to block 836 to generate an optimization problem in the form of Inequality 8. At block 838, the optimization problem may be solved to generate and implement a charging/load trajectory. If, at block 834, there is equipment with an “unknown” label, at block 840, a determination may be made regarding whether the equipment is a generator and/or bi-directional equipment. If not, the process proceeds to block 842, where all equipment phases are replaced with a “unknown” and then all unknown phases are replaced with phase A. The process the proceeds to block 836 to generate an optimization problem and then to block 838 to solve the optimization problem, as well as to generate and implement a charging/load trajectory. If, at block 840, there are generators and/or bi-directional equipment, the process proceeds to block 844 to generate an error.

Example Process for Accounting for an Unknown Phase with Hybrid Constraints

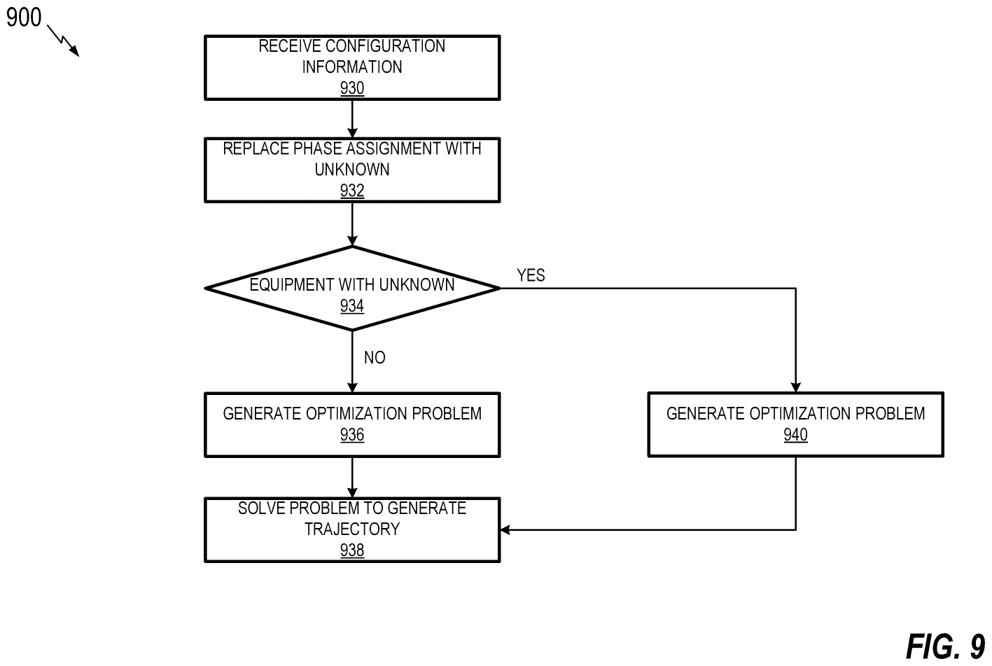

FIG. 9 depicts a flowchart 900 for accounting for an unknown phase with hybrid constraints, according to embodiments provided herein. As illustrated in block 930, a configuration information may be received. In block 932, any previous phase assignments that are missing and/or invalid may be replaced with an “unknown” label. In some embodiments, these blocks may be performed in the cloud environment 104 via the optimization API 525. This data may be sent to the edge environment 102 for processing via the optimization and control manager 203.

In block 934, a determination may be made regarding whether there is any equipment with an “unknown” label. If not, an optimization problem according to Inequality 8 above may be generated in block 936 and the optimization problem may be solved to generate and implement a charging/load trajectory in block 938. If, at block 934, there is equipment with an “unknown” label, at block 940, the optimization problem may be generated according to Inequality 13 and the process proceeds to block 938 to solve the problem to generate and implement the trajectory.

### Example Process for Building Constraints

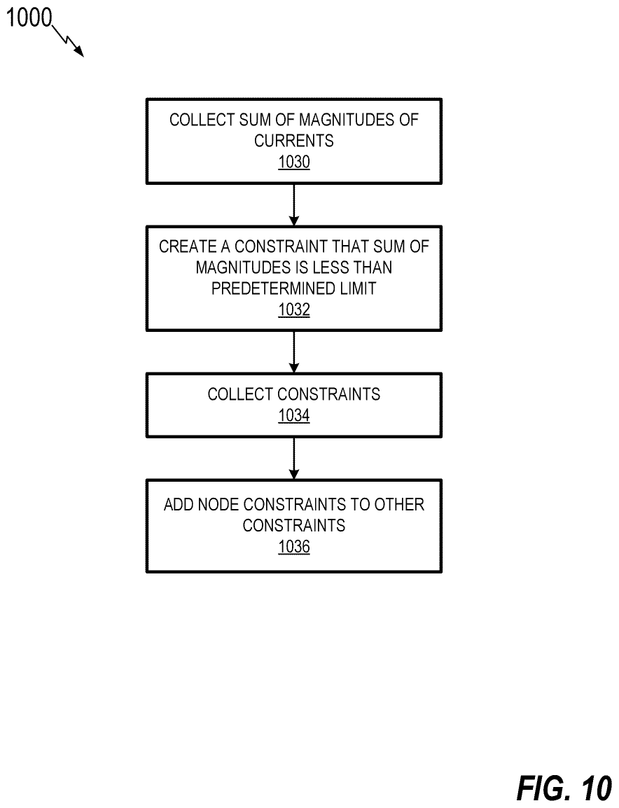

FIG. 10 depicts a flowchart 1000 for building constraints in the form of Inequality 7, according to embodiments provided herein. As illustrated in block 1030, for each network node, the sum of magnitudes of the currents drawn by the respective network nodes' children (EVSE below the current EVSE in the network) may be collected. In block 1032, for each network node, a constraint that the sum of the magnitudes of all currents drawn by its children is less than its current limit may be created. In block 1034, the constraints for network nodes may be collected. In block 1036, network node constraints may be added to other constraints for optimization.

### Another Example Process for Building Constraints

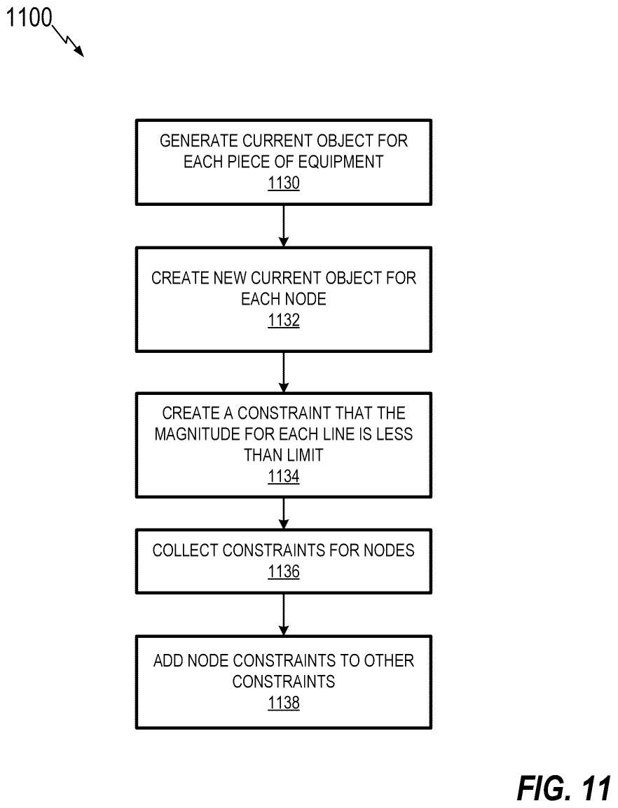

FIG. 11 depicts a flowchart 1100 for building constraints in the form of Inequalities 4 and/or 13, according to embodiments provided herein. As illustrated in block 1130, a current object may be generated to store current draw/injection from each piece of equipment. In block 1132, for each network node, a new current object may be created, which is the sum of some or all current objects from the children of that node. In block 1134, for each network node, an iteration may be performed over each line in its current object. For each line, a constraint that the magnitude of the current in that line is less than a predetermined network node limit may be created. In block 1136, the constraints for all network nodes may be created and/or collected. In block 1138, network node constraints may be added to other constraints for optimization.

### Example Process for Generating a Current Object

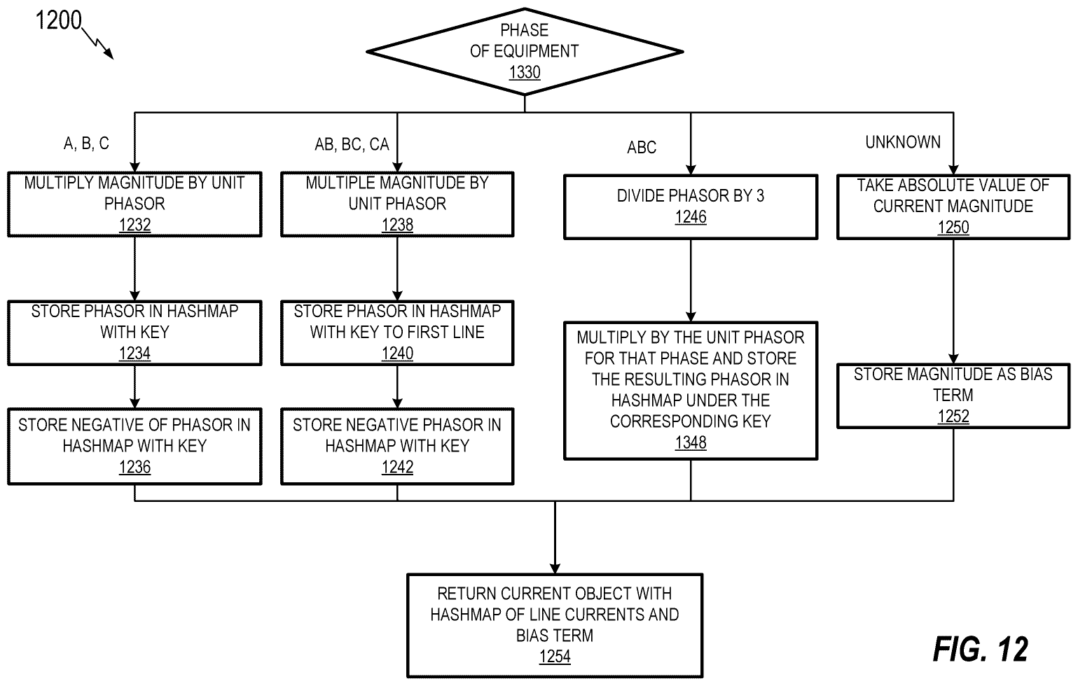

FIG. 12 depicts a flowchart 1200 for generating a current object as described in FIG. 11, according to embodiments provided herein. In block 1230, a determination may be made regarding the phase of the equipment. If the phase of the equipment is A, B, C, the process proceeds to block 1232, where the magnitude is multiplied by a first unit phasor for the corresponding phase. In block 1234, the first unit phasor may be stored in a hashmap with a first key corresponding to the correct line. In block 1236, a negative of the first unit phasor may be stored in the hashmap with a key to a neutral line. If at block 1230, the phase is AB, BC, CA, the process moves to block 1238, where the magnitude may be multiplied by a second unit phasor for the corresponding phase. In block 1240, the second unit phasor may be stored in the hashmap with a second key to the first line (e.g., A for phase AB). In block 1242, a negative of the second phasor may be stored in the hashmap with a key corresponding to the first line (e.g., B for phase AB).

If at block 1230, it is determined that the phase is ABC, the process proceeds to block 1246, where a third unit phasor may be divided by 3. In block 1248, a multiplication by the third unit phasor may be performed for that phase and the resulting unit phasor may be stored in the hashmap under the corresponding key. If in block 1230, the phase is unknown, the process may proceed to block 1240, where the absolute value of the current magnitude may be taken. In block 1252, the magnitude may be stored as a bias term. From each of the branches, the process may then proceed to block 1254, where the current object may be returned with line currents from the hashmap and a bias term.

### Example Process for Adding a Current Object

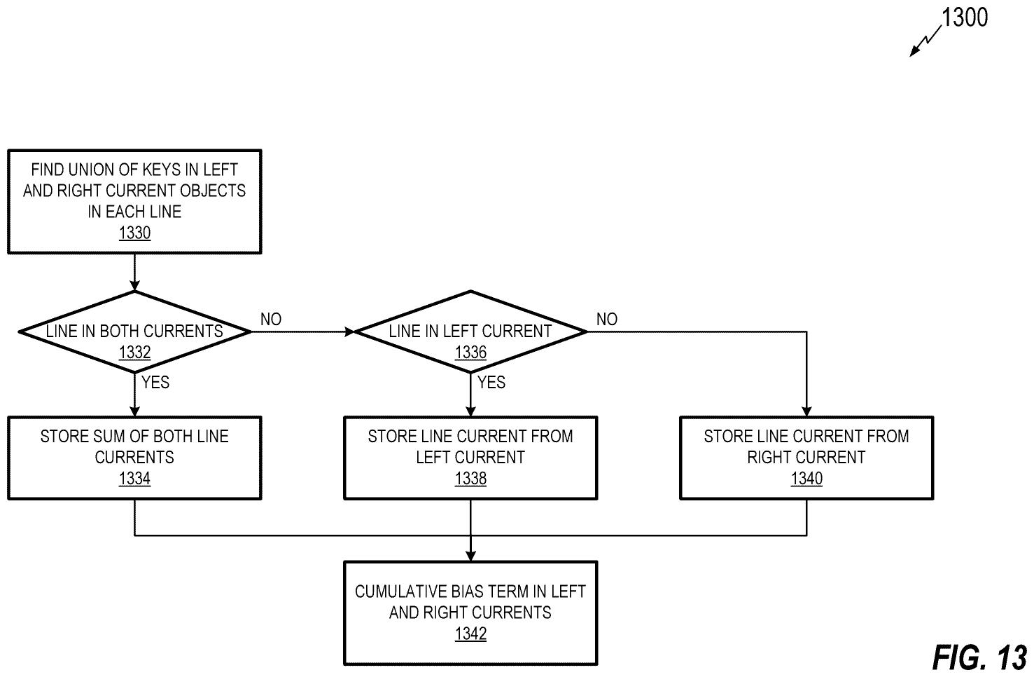

FIG. 13 depicts a flowchart 1300 for adding a current object such as from FIG. 12, according to embodiments provided herein. As illustrated in block 1330, a union of keys in left current and right current objects may be found in each line. In block 1332, a determination may be made regarding whether there is a line in both the left current and the right current. If so, in block 1334, the sum of both the left line current and the right line current may be stored. If not, in block 1336, a determination may be made regarding whether there is a line in the left current. If so, in block 1338, the line current may be stored from the left current. If not, in block 1340, the line current from the right current may be stored. From each of the branches, in block 1342, the left and right currents are summed.

### Example Clauses

Implementation examples are described in the following numbered clauses:

Clause 1: A system comprising: an electric vehicle supply equipment (EVSE) for charging an electric vehicle (EV), the EVSE including a three-phase transformer for sending energy to the EV; and an edge environment that is coupled to the EVSE, wherein the edge environment includes a computing device that includes a memory component and a processor, wherein the memory component stores logic that, when executed by the computing device, causes the system to perform at least the following: receive configuration information associated with the EVSE, wherein the configuration information includes a phase assignment for the EVSE; determine whether the phase assignment is labeled as unknown, wherein the phase assignment of unknown was applied in response to a determination that a previous phase assignment was invalid or missing; generate an optimization problem for the EVSE; solve the optimization problem to generate a trajectory for the three-phase transformer; and cause implementation of the trajectory on the EVSE.

Clause 2: The system of clause 1, further comprising a cloud environment that is remote from the edge environment, the cloud environment storing an application program interface (API) for receiving the configuration information from the EVSE, determining whether the previous phase assignment is missing or invalid, and in response to determining that the previous phase assignment is missing or invalid, replacing the previous phase assignment with the phase assignment of unknown.

Clause 3: The system of clause 1 and/or 2, wherein in response to determining that the phase assignment is not labeled as unknown, generating the optimization problem according to

$$‖ {\sum }_{i ∈ {v}_{k}} {r}_{i} ( t ) {P}_{{ϕ}_{i}}^{j} ‖ \leq {L}_{k} ( t ) \qquad ∀ j ∈ \{ 0 , 1 , 2 , 3 \} .$$

Clause 4: The system of any of clauses 1 through 3, wherein in response to determining that the phase assignment is labeled as unknown, the logic further causes the system to determine whether there are any generators or bi-directional equipment in the EVSE and, in response to determining there are not generators or bi-directional equipment in the EVSE, generate the optimization problem according to Σ_{i∈ν}_{ₖ}rᵢ(t)≤Lₖ(t).

Clause 5: The system of any of clauses 1 through 4, wherein the EVSE is part of a network with a plurality of network nodes, wherein generating the optimization problem according to Σ_{i∈ν}_{ₖ}rᵢ(t)≤Lₖ(t) includes at least the following: collecting sums of magnitudes of network nodes below the EVSE in the network; creating a constraint that the sums of magnitudes drawn by the network nodes below the EVSE is less than a current limit; and adding network node constraints to other constraints for optimization.

Clause 6: The system of any of clauses 1 through 5, wherein in response to determining that the phase assignment is labeled as unknown, the logic further causes the system to determine whether there are any generators or bi-directional equipment in the EVSE and, in response to determining there are not generators or bi-directional equipment in the EVSE, replace the phase assignment with an unknown label, replace the unknown phase label with phase A, and generating the optimization problem according to

$$‖ {\sum }_{i ∈ {v}_{k}} {r}_{i} ( t ) {P}_{{ϕ}_{i}}^{j} ‖ \leq {L}_{k} ( t ) \qquad ∀ j ∈ \{ 0 , 1 , 2 , 3 \} .$$

Clause 7: The system of any of clauses 1 through 6, wherein generating the optimization problem utilizing

$${‖I}_{k}^{j} ( t ) ‖ \leq ‖ {Σ}_{i ∈ {k}_{}} {r}_{i} ( t ) {P}_{{ϕ}_{k}}^{j} ‖ + {Σ}_{i ∈ {k}_{}} \vert {r}_{i} ( t ) \vert \leq {L}_{k} ( t ) j ∈ \{ 0 , 1 , 2 , 3 \}$$

includes at least the following: generate a current object to store a current draw from the EVSE; create a new current object representing a sum of current objects from equipment below the EVSE; create a constraint that a magnitude of a current in that line is less than a predetermined network node limit; and add network node constraints to other constraints.

Clause 8: The system of any of clauses 1 through 7, wherein generating the optimization problem utilizing

$${‖I}_{k}^{j} ( t ) ‖ \leq ‖ {Σ}_{i ∈ {k}_{}} {r}_{i} ( t ) {P}_{{ϕ}_{k}}^{j} ‖ + {Σ}_{i ∈ {k}_{}} \vert {r}_{i} ( t ) \vert \leq {L}_{k} ( t ) j ∈ \{ 0 , 1 , 2 , 3 \}$$

includes at least the following: generate a current object to store a current draw from the EVSE; create a new current object representing a sum of current objects from equipment below the EVSE; create a constraint that a magnitude of a current in that line is less than a predetermined network node limit; and add network node constraints to other constraints.

Clause 9: The system of any of clauses 1 through 8, wherein in generating the current object, the logic further causes the system to determine a phase of the EVSE, wherein the phase of the EVSE includes one of the following: A, B, C; AB, BC, CA; ABC; or unknown.

Clause 10: The system of any of clauses 1 through 9, in response to determining that the phase of the EVSE is A, B, C, the logic further causes the system to multiply the magnitude of the current by a first unit phasor to form a first current phasor, store the first current phasor in a hashmap with a first key, store a negative of the first current phasor in the hashmap with a second key representing the neutral line and return the current object with line currents from the hashmap and a bias term, in response to determining that the phase of the EVSE is AB, BC, CA, the logic further causes the system to multiply the magnitude of the current by a second unit phasor to form a second current phasor, store the second current phasor with a third key to a first line, and store the negative of the second current phasor in the hashmap with the fourth key to a second line, in response to determining that the phase of the EVSE is ABC, the logic further causes the system to divide the magnitude of the phase by 3, multiply the resulting magnitude of each line by a third unit phasor corresponding to that phase to get a third current phasor, and store the third current phasor in the hashmap under the corresponding key for that line, and in response to determining that the phase of the EVSE is unknown, the logic further causes the system to take absolute value of the magnitude, store the magnitude as the bias term, and return the current object with the line currents from the hashmap and the bias term.

Clause 11: The system of any of clauses 1 through 10, wherein the logic further causes the system to add current objects, which includes at least the following: find union of the first key, the second key, and the keys A, B, C; determine if there is a line in both a left current and a right current; in response to determining that there is a line in both the left current and the right current, store a sum of both the left current and the right current and sum a respective bias term in the left current and the right current; in response to determining that there is not a line in both the left current and the right current, determine if there is a line in the left current; in response to determining that there is a line in the left current, store a line current from the left current and sum the respective bias term in a left line current and a right line current; and in response to determining that there is not a line in the left current, store the line current from the right current and sum the respective bias term in the left line current and the right line current.

Clause 12: A method comprising: receiving, by a computing device, configuration information from an electric vehicle supply equipment (EVSE) for charging an electric vehicle (EV) utilizing a three-phase transformer; determining, by the computing device, whether a previous phase assignment is missing or invalid; in response to determining that the previous phase assignment is missing or invalid, replacing, by the computing device, the previous phase assignment with the phase assignment of unknown; determining, by the computing device, whether a phase assignment is labeled as unknown; generating, by the computing device, an optimization problem for the EVSE; solving, by the computing device, the optimization problem to generate a trajectory for the three-phase transformer; and causing, by the computing device, implementation of the trajectory on the EVSE.

Clause 13: The method of clause 12, wherein in response to determining that the phase assignment is not labeled as unknown, generating the optimization problem according to

$$‖ {\sum }_{i ∈ {v}_{k}} {r}_{i} ( t ) {P}_{{ϕ}_{i}}^{j} ‖ \leq {L}_{k} ( t ) \qquad ∀ j ∈ \{ 0 , 1 , 2 , 3 \} ,$$

and wherein in response to determining that the phase assignment is labeled as unknown, the method further comprises determining whether there are any generators or bi-directional equipment in the EVSE and, in response to determining there are not generators or bi-directional equipment in the EVSE, generate the optimization problem according to Σ_{i∈ν}_{ₖ}rᵢ(t)≤Lₖ(t).

Clause 14: The method of clauses 12 and/or 13, wherein in response to determining that the phase assignment is labeled as unknown, the method further comprises determining whether there are any generators or bi-directional equipment in the EVSE and, in response to determining there are not generators or bi-directional equipment in the EVSE, replace the phase assignment with an unknown label, replace the unknown phase label with phase A, and generating the optimization problem according to

$$‖ {\sum }_{i ∈ {v}_{k}} {r}_{i} ( t ) {P}_{{ϕ}_{i}}^{j} ‖ \leq {L}_{k} ( t ) \qquad ∀ j ∈ \{ 0 , 1 , 2 , 3 \} .$$

Clause 15: The method of any of clauses 12 through 14, wherein generating the optimization problem for the EVSE includes utilizing

$${‖I}_{k}^{j} ( t ) ‖ \leq ‖ {Σ}_{i ∈ {k}_{}} {r}_{i} ( t ) {P}_{{ϕ}_{k}}^{j} ‖ + {Σ}_{i ∈ {k}_{}} \vert {r}_{i} ( t ) \vert \leq {L}_{k} ( t ) j ∈ \{ 0 , 1 , 2 , 3 \}$$

to generate the optimization problem.

Clause 16: The method of any of clauses 12 through 15, wherein generating the optimization problem utilizing

$$‖ {I}_{k}^{j} ( t ) ‖ \leq ‖ {\sum }_{i ∈ {k}_{}} {r}_{i} ( t ) {P}_{{ϕ}_{k}}^{j} ‖ + {\sum }_{i ∈ {k}_{}} \vert {r}_{i} ( t ) \vert \leq {L}_{k} ( t ) j ∈ \{ 0 , 1 , 2 , 3 \}$$

includes at least the following: generate a current object to store current draw from the EVSE, wherein in generating the current object, includes determining a phase of the EVSE, wherein the phase of the EVSE includes one of the following: A, B, C; AB, BC, CA; ABC; or unknown; create a new current object representing a sum of current objects from the equipment below the EVSE; create a constraint that a magnitude of a current in that line is less than a predetermined network node limit; and add network node constraints to other constraints, wherein: in response to determining that the phase of the EVSE is A, B, C, the method further comprises multiplying the magnitude of the current by a first unit phasor to form a first current phasor, storing the first current phasor in a hashmap with a first key, storing a negative of the first current phasor in the hashmap with a second key representing the neutral line and return the current object with line currents from the hashmap and a bias term, in response to determining that the phase of the EVSE is AB, BC, CA, the method further comprises dividing the magnitude of the phase by 3, multiplying the resulting magnitude of each line by a third unit phasor corresponding to that phase to get a third current phasor, and storing the third current phasor in the hashmap under the corresponding key for that line, in response to determining that the phase of the EVSE is ABC, the method further comprises dividing the magnitude by 3, multiply the magnitude by a unit phasor for keys A, B, C, and store the third unit phasor in the hashmap under keys A, B, C, and in response to determining that the phase of the EVSE is unknown, the method further comprises taking take absolute value of the magnitude, storing the magnitude as the bias term, and return the current object with the line currents from the hashmap and the bias term.

Clause 17: A non-transitory computer-readable medium comprising computer-executable instructions that, when executed by a processor of a processing system, cause the processing system to perform at least the following: receive configuration information from an electric vehicle supply equipment (EVSE) for charging an electric vehicle (EV) utilizing a three-phase transformer; determine whether a previous phase assignment is missing or invalid; in response to determining that the previous phase assignment is missing or invalid, replace the previous phase assignment with the phase assignment of unknown; determine whether a phase assignment is labeled as unknown; generate an optimization problem for the EVSE; solve the optimization problem to generate a trajectory for the three-phase transformer; and cause implementation of the trajectory on the EVSE.

Clause 18: The non-transitory computer-readable medium of clause 16, wherein in response to determining that the phase assignment is not labeled as unknown, generating the optimization problem according to

$$‖ {\sum }_{i ∈ {V}_{k}} {r}_{i} ( t ) {P}_{{ϕ}_{i}}^{j} ‖ \leq {L}_{k} ( t ) ∀ j ∈ \{ 0 , 1 , 2 , 3 \} ,$$

and wherein in response to determining that the phase assignment is labeled as unknown, the logic further causes the processing system to determine whether there are any generators or bi-directional equipment in the EVSE and, in response to determining there are not generators or bi-directional equipment in the EVSE, generate the optimization problem according to Σ_{i∈ν}_{ₖ}rᵢ(t)≤Lₖ(t).

Clause 19: The non-transitory computer-readable medium of clause 17 and/or 18, wherein in response to determining that the phase assignment is labeled as unknown, the logic further causes the processing system to determine whether there are any generators or bi-directional equipment in the EVSE and, in response to determining there are not generators or bi-directional equipment in the EVSE, replace the phase assignment with an unknown label, replace the unknown phase label with phase A, and generating the optimization problem according to

$$‖ {\sum }_{i ∈ {V}_{k}} {r}_{i} ( t ) {P}_{{ϕ}_{i}}^{j} ‖ \leq {L}_{k} ( t ) ∀ j ∈ \{ 0 , 1 , 2 , 3 \} .$$

Clause 20: The non-transitory computer-readable medium of any of clauses 17 through 19, wherein generating the optimization problem for the EVSE includes utilizing

$$‖ {I}_{k}^{j} ( t ) ‖ \leq ‖ {\sum }_{i ∈ {k}_{}} {r}_{i} ( t ) {P}_{{ϕ}_{k}}^{j} ‖ + {\sum }_{i ∈ {k}_{}} \vert {r}_{i} ( t ) \vert \leq {L}_{k} ( t ) j ∈ \{ 0 , 1 , 2 , 3 \}$$

to generate the optimization problem.

Clause 21: A processing system, comprising: a memory comprising computer-executable instructions; and a processor configured to execute the computer-executable instructions and cause the processing system to perform a method in accordance with any one of Clauses 12-16.

Clause 22: A processing system, comprising means for performing a method in accordance with any one of Clauses 12-16.

Clause 23: A non-transitory computer-readable medium comprising computer-executable instructions that, when executed by a processor of a processing system, cause the processing system to perform a method in accordance with any one of Clauses 12-16.

Clause 24: A computer program product embodied on a computer-readable storage medium comprising code for performing a method in accordance with any one of Clauses 12-16.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system comprising:
an electric vehicle supply equipment (EVSE) for charging an electric vehicle (EV), the EVSE including a three-phase transformer for sending energy to the EV; and
an edge environment that is coupled to the EVSE, wherein the edge environment includes a computing device that includes a memory component and a processor, wherein the memory component stores logic that, when executed by the computing device, causes the system to perform at least the following:
receive configuration information associated with the EVSE, wherein the configuration information includes a phase assignment for the EVSE;
determine whether the phase assignment is labeled as unknown, wherein the phase assignment of unknown was applied in response to a determination that a previous phase assignment was invalid or missing;
generate an optimization problem for the EVSE;
solve the optimization problem to generate a trajectory for the three-phase transformer; and
cause implementation of the trajectory on the EVSE.

2. The system of claim 1, further comprising a cloud environment that is remote from the edge environment, the cloud environment storing an application program interface (API) for receiving the configuration information from the EVSE, determining whether the previous phase assignment is missing or invalid, and in response to determining that the previous phase assignment is missing or invalid, replacing the previous phase assignment with the phase assignment of unknown.

3. The system of claim 1, wherein in response to determining that the phase assignment is not labeled as unknown, generating the optimization problem according to
$$‖ {\sum }_{i ∈ {V}_{k}} {r}_{i} ( t ) {P}_{{ϕ}_{i}}^{j} ‖ \leq {L}_{k} ( t ) ∀ j ∈ \{ 0 , 1 , 2 , 3 \} .$$

4. The system of claim 1, wherein in response to determining that the phase assignment is labeled as unknown, the logic further causes the system to determine whether there are any generators or bi-directional equipment in the EVSE and, in response to determining there are not generators or bi-directional equipment in the EVSE, generate the optimization problem according to Σ_{i∈ν}_{ₖ} rᵢ(t)≤Lₖ(t).

5. The system of claim 4, wherein the EVSE is part of a network with a plurality of network nodes, wherein generating the optimization problem according to Σ_{i∈ν}_{ₖ} rᵢ(t)≤Lₖ(t) includes at least the following:
collecting sums of magnitudes of network nodes below the EVSE in the network;
creating a constraint that the sums of magnitudes drawn by the network nodes below the EVSE is less than a current limit; and
adding network node constraints to other constraints for optimization.

6. The system of claim 1, wherein in response to determining that the phase assignment is labeled as unknown, the logic further causes the system to determine whether there are any generators or bi-directional equipment in the EVSE and, in response to determining there are not generators or bi-directional equipment in the EVSE, replace the phase assignment with an unknown label, replace the unknown phase label with phase A, and generating the optimization problem according to
$$‖ {\sum }_{i ∈ {V}_{k}} {r}_{i} ( t ) {P}_{{ϕ}_{i}}^{j} ‖ \leq {L}_{k} ( t ) ∀ j ∈ \{ 0 , 1 , 2 , 3 \} .$$

7. The system of claim 1, wherein generating the optimization problem for the EVSE includes utilizing
$$‖ {I}_{k}^{j} ( t ) ‖ \leq ‖ {\sum }_{i ∈ {k}_{}} {r}_{i} ( t ) {P}_{{ϕ}_{k}}^{j} ‖ + {\sum }_{i ∈ {k}_{}} \vert {r}_{i} ( t ) \vert \leq {L}_{k} ( t ) j ∈ \{ 0 , 1 , 2 , 3 \}$$
to generate the optimization problem.

8. The system of claim 7, wherein generating the optimization problem utilizing
$$‖ {I}_{k}^{j} ( t ) ‖ \leq ‖ {\sum }_{i ∈ {k}_{}} {r}_{i} ( t ) {P}_{{ϕ}_{k}}^{j} ‖ + {\sum }_{i ∈ {k}_{}} \vert {r}_{i} ( t ) \vert \leq {L}_{k} ( t ) j ∈ \{ 0 , 1 , 2 , 3 \}$$
includes at least the following:
generate a current object to store a current draw from the EVSE;
create a new current object representing a sum of current objects from equipment below the EVSE;
create a constraint that a magnitude of a current in that line is less than a predetermined network node limit; and
add network node constraints to other constraints.

9. The system of claim 8, wherein in generating the current object, the logic further causes the system to determine a phase of the EVSE, wherein the phase of the EVSE includes one of the following: A, B, C; AB, BC, CA; ABC; or unknown.

10. The system of claim 9, wherein:
in response to determining that the phase of the EVSE is A, B, C, the logic further causes the system to multiply the magnitude of the current by a first unit phasor to form a first current phasor, store the first current phasor in a hashmap with a first key, store a negative of the first current phasor in the hashmap with a second key representing the neutral line and return the current object with line currents from the hashmap and a bias term,
in response to determining that the phase of the EVSE is AB, BC, CA, the logic further causes the system to multiply the magnitude of the current by a second unit phasor to form a second current phasor, store the second current phasor with a third key to a first line, and store the negative of the second current phasor in the hashmap with the fourth key to a second line,
in response to determining that the phase of the EVSE is ABC, the logic further causes the system to divide the magnitude of the phase by 3, multiply the resulting magnitude of each line by a third unit phasor corresponding to that phase to get a third current phasor, and store the third current phasor in the hashmap under the corresponding key for that line, and
in response to determining that the phase of the EVSE is unknown, the logic further causes the system to take absolute value of the magnitude, store the magnitude as the bias term, and return the current object with the line currents from the hashmap and the bias term.

11. The system of claim 10, wherein the logic further causes the system to add current objects, which includes at least the following:
find union of the first key, the second key, and the keys A, B, C;
determine if there is a line in both a left current and a right current;
in response to determining that there is a line in both the left current and the right current, store a sum of both the left current and the right current and sum a respective bias term in the left current and the right current;
in response to determining that there is not a line in both the left current and the right current, determine if there is a line in the left current;
in response to determining that there is a line in the left current, store a line current from the left current and sum the respective bias term in a left line current and a right line current; and
in response to determining that there is not a line in the left current, store the line current from the right current and sum the respective bias term in the left line current and the right line current.

12. A method comprising:
receiving, by a computing device, configuration information from an electric vehicle supply equipment (EVSE) for charging an electric vehicle (EV) utilizing a three-phase transformer;
determining, by the computing device, whether a previous phase assignment is missing or invalid;
in response to determining that the previous phase assignment is missing or invalid, replacing, by the computing device, the previous phase assignment with the phase assignment of unknown;
determining, by the computing device, whether a phase assignment is labeled as unknown;
generating, by the computing device, an optimization problem for the EVSE;
solving, by the computing device, the optimization problem to generate a trajectory for the three-phase transformer; and
causing, by the computing device, implementation of the trajectory on the EVSE.

13. The method of claim 12, wherein in response to determining that the phase assignment is not labeled as unknown, generating the optimization problem according to
$$‖ {\sum }_{i ∈ {V}_{k}} {r}_{i} ( t ) {P}_{{ϕ}_{i}}^{j} ‖ \leq {L}_{k} ( t ) ∀ j ∈ \{ 0 , 1 , 2 , 3 \} ,$$
and
wherein in response to determining that the phase assignment is labeled as unknown, the method further comprises determining whether there are any generators or bi-directional equipment in the EVSE and, in response to determining there are not generators or bi-directional equipment in the EVSE, generate the optimization problem according to Σ_{i∈ν}_{ₖ} rᵢ(t)≤Lₖ(t).

14. The method of claim 12, wherein in response to determining that the phase assignment is labeled as unknown, the method further comprises determining whether there are any generators or bi-directional equipment in the EVSE and, in response to determining there are not generators or bi-directional equipment in the EVSE, replace the phase assignment with an unknown label, replace the unknown phase label with phase A, and generating the optimization problem according to
$$‖ {\sum }_{i ∈ {V}_{k}} {r}_{i} ( t ) {P}_{{ϕ}_{i}}^{j} ‖ \leq {L}_{k} ( t ) ∀ j ∈ \{ 0 , 1 , 2 , 3 \} .$$

15. The method of claim 12, wherein generating the optimization problem for the EVSE includes utilizing
$$‖ {I}_{k}^{j} ( t ) ‖ \leq ‖ {\sum }_{i ∈ {k}_{}} {r}_{i} ( t ) {P}_{{ϕ}_{k}}^{j} ‖ + {\sum }_{i ∈ {k}_{}} \vert {r}_{i} ( t ) \vert \leq {L}_{k} ( t ) j ∈ \{ 0 , 1 , 2 , 3 \}$$
to generate the optimization problem.

16. The method of claim 15, wherein generating the optimization problem utilizing
$$‖ {I}_{k}^{j} ( t ) ‖ \leq ‖ {\sum }_{i ∈ {k}_{}} {r}_{i} ( t ) {P}_{{ϕ}_{k}}^{j} ‖ + {\sum }_{i ∈ {k}_{}} \vert {r}_{i} ( t ) \vert \leq {L}_{k} ( t ) j ∈ \{ 0 , 1 , 2 , 3 \}$$
includes at least the following:
generate a current object to store current draw from the EVSE, wherein in generating the current object, includes determining a phase of the EVSE, wherein the phase of the EVSE includes one of the following: A, B, C; AB, BC, CA; ABC; or unknown;
create a new current object representing a sum of current objects from the equipment below the EVSE;
create a constraint that a magnitude of a current in that line is less than a predetermined network node limit; and
add network node constraints to other constraints,
wherein:
in response to determining that the phase of the EVSE is A, B, C, the method further comprises multiplying the magnitude of the current by a first unit phasor to form a first current phasor, storing the first current phasor in a hashmap with a first key, storing a negative of the first current phasor in the hashmap with a second key representing the neutral line and return the current object with line currents from the hashmap and a bias term,
in response to determining that the phase of the EVSE is AB, BC, CA, the method further comprises dividing the magnitude of the phase by 3, multiplying the resulting magnitude of each line by a third unit phasor corresponding to that phase to get a third current phasor, and storing the third current phasor in the hashmap under the corresponding key for that line,
in response to determining that the phase of the EVSE is ABC, the method further comprises dividing the magnitude by 3, multiply the magnitude by a unit phasor for keys A, B, C, and store the third unit phasor in the hashmap under keys A, B, C, and
in response to determining that the phase of the EVSE is unknown, the method further comprises taking take absolute value of the magnitude, storing the magnitude as the bias term, and return the current object with the line currents from the hashmap and the bias term.

17. A non-transitory computer-readable medium comprising computer-executable instructions that, when executed by a processor of a processing system, cause the processing system to perform at least the following:
receive configuration information from an electric vehicle supply equipment (EVSE) for charging an electric vehicle (EV) utilizing a three-phase transformer;
determine whether a previous phase assignment is missing or invalid;
in response to determining that the previous phase assignment is missing or invalid, replace the previous phase assignment with the phase assignment of unknown;
determine whether a phase assignment is labeled as unknown;
generate an optimization problem for the EVSE;
solve the optimization problem to generate a trajectory for the three-phase transformer; and
cause implementation of the trajectory on the EVSE.

18. The non-transitory computer-readable medium of claim 17, wherein in response to determining that the phase assignment is not labeled as unknown, generating the optimization problem according to
$$‖ {\sum }_{i ∈ {V}_{k}} {r}_{i} ( t ) {P}_{{ϕ}_{i}}^{j} ‖ \leq {L}_{k} ( t ) ∀ j ∈ \{ 0 , 1 , 2 , 3 \} ,$$
and
wherein in response to determining that the phase assignment is labeled as unknown, the logic further causes the processing system to determine whether there are any generators or bi-directional equipment in the EVSE and, in response to determining there are not generators or bi-directional equipment in the EVSE, generate the optimization problem according to Σ_{i∈ν}_{ₖ}rᵢ(t)≤Lₖ(t).

19. The non-transitory computer-readable medium of claim 17, wherein in response to determining that the phase assignment is labeled as unknown, the logic further causes the processing system to determine whether there are any generators or bi-directional equipment in the EVSE and, in response to determining there are not generators or bi-directional equipment in the EVSE, replace the phase assignment with an unknown label, replace the unknown phase label with phase A, and generating the optimization problem according to
$$‖ {\sum }_{i ∈ {V}_{k}} {r}_{i} ( t ) {P}_{{ϕ}_{i}}^{j} ‖ \leq {L}_{k} ( t ) ∀ j ∈ \{ 0 , 1 , 2 , 3 \} .$$

20. The non-transitory computer-readable medium of claim 17, wherein generating the optimization problem for the EVSE includes utilizing
$$‖ {I}_{k}^{j} ( t ) ‖ \leq ‖ {\sum }_{i ∈ {k}_{}} {r}_{i} ( t ) {P}_{{ϕ}_{k}}^{j} ‖ + {\sum }_{i ∈ {k}_{}} \vert {r}_{i} ( t ) \vert \leq {L}_{k} ( t ) j ∈ \{ 0 , 1 , 2 , 3 \}$$
to generate the optimization problem.
